(19) United States
(12) Patent Application Publication
(10) Pub. No.: US 2023/0296566 A1
(43) Pub. Date: Sep. 21, 2023

(54) EMAT SYSTEM FOR DETECTING SURFACE AND INTERNAL DISCONTINUITIES IN CONDUCTIVE STRUCTURES AT HIGH TEMPERATURE

(71) Applicant: STEELEMAT S.À R.L, Luxembourg (LU)

(72) Inventors: Alexey EVDOKIMOV, Moscou (RU); Artemii SUBBOTIN, Odintsovo (RU); Sergii MALYNKA, dnipro (UA)

(21) Appl. No.: 18/018,889

(22) PCT Filed: Oct. 13, 2021
(86) PCT No.: PCT/IB2021/059408

§ 371 Date: Jan. 31, 2023

(30) Foreign Application Priority Data
Sep. 9, 2020 (FR) FR2009138

(51) Int. Cl. G01N 29/24; G01N 29/04

(52) U.S. Cl. CPC G01N 29/2412; G01N 29/041; G01N 29/043; G01N 29/2418; G01N 2291/0234

(57) ABSTRACT

An EMAT system (1) for detecting surface and internal discontinuities (2) in thick conductive structures (90) at high temperatures, comprising a magnet (4) that generates a static magnetic field (SMF) and an HF electric coil (6) for inducing, or being induced by, eddy currents in the material (14). It comprises a perforated matrix-array laminated magnetic core (22) placed between the HF electric coil (6) and the inspected material (3), which is made up of a multitude of apertured HF active laminae (29) incorporating a ferromagnetic material, and of apertured insulating passive laminae (53). Trough-holes (41, 57) are drilled through each lamina (29, 53) and form a grooved cylindrical aperture (39). Parallel induced-current loops (43) encircle each magnetic trough-hole (41) of the HF active laminae (29). Cooling means (58) force a heat-transfer fluid (60) to pass through the grooved cylindrical aperture (39).

### TECHNICAL FIELD

This invention relates generally to non-destructive ultrasonic testing technology (UNDT). It relates specifically to an electromagnetic acoustic transducer (EMAT) for UNT applications, its modes of implementation and its industrial applications.

The technical field of the invention relates specifically to EMAT transducers:
a. Which are non-vibrating type transducers, which do not vibrate mechanically, but induce and/or receive ultrasonic mechanical vibrations by electromagnetic means;
b. To study or analyse materials using transmitter means and/or receiver means adapted to induce ultrasonic waves in a conductive test body or to receive ultrasonic waves from this body for testing, by electromagnetic means; and, for viewing the inside of the objects by transmitting and/or receiving such an ultrasonic wave emitted through the object; and,
c. As such, which belong to the international class of patents Int. Cl. G01N 29/24 and/or the class of US Pat. Nos. Cl. 73/643.

The technical field of the invention is limited to EMAT transducers which are furthermore:
a. Equipped with significant electromagnetic coupling means, located between the active electromagnetic parts of the transducer and the test body, in order to increase the coupling of a high-frequency magnetic field between the active electromagnetic parts of the transducer and the surface of the conductive test body through which eddy currents flow; and,
b. Of the specific type whose electromagnetic coupling means consist of a laminated magnetic core, made of a matrix of laminated thin sheets incorporating internally either a ferromagnetic or ferrimagnetic material; and,
c. Of the specific type, the electromagnetic coupling means of which are equipped with active cooling means, in order to dissipate the thermal energy generated by current loops induced on the periphery of the laminated thin sheets of their electromagnetic coupling means.

The invention is preferably implemented in equipment of Laser-EMAT type and/or in an EMAT-EMAT equipment, which combines both: an ultrasound generator consisting of a high-power pulse laser or an EMAT generating ultrasounds, and an ultrasound EMAT receiver.

The preferred use of the invention is the 3D objective physical scanning and the non-destructive ultrasonic UNDT test, at high throughput of the surface and internal discontinuities, in a production line of large structures, and/or of thick structures, and/or of components, manufactured from a conductive material, such as steel slabs during their casting, in a high- industrial environment at temperature higher than 1000° C.

The invention can be used to automatically optimize the setting of the parameters of the dynamic reduction (DNS) and/or of the dynamic secondary cooling (DSC) of a continuous casting of a strand of steel slabs in a steel mill, at a temperature greater than 1000° C.

### BACKGROUND ART

EMAT technologies are used for the non-destructive testing of structures made of a conductive material, under difficult conditions. Non-destructive testing (NDT) technologies are commonly used in industrial environments, for structural monitoring or inspection of structures and components of various shapes and sizes without damaging them. However, the operating conditions and the temperature, the type of implementation, the size and the structural complexity of the components tested for inspection, limit the number and types of available NDT techniques that can be used effectively and their applications. The raw data provided by the NDT systems of the prior art are not suitable for sophisticated and deep detection of defects and their 3D location, in large components treated under severe and/or extremely hot operating conditions at temperature greater than 1000° C., such as those encountered during the continuous casting of strands of steel slabs in steel mills.

Ultrasonic Non-Destructive Control (UNDT) is a family of NDT based on the propagation of ultrasonic waves in the object or the equipment under test. In conventional UNDT tests, an ultrasound probe connected to a diagnostic machine is passed over the inspected object. Conventional UNDT methods use mechanical wave beams of short wavelength and high frequency, transmitted from an ultrasound generating probe through the tested material, and detected by the same probe or another ultrasound receiving probe, to identify the structural defects of the component. The main probes for performing UNDT tests are piezoelectric transducers, laser transducers and electromagnetic acoustic transducers (EMAT). Conventional piezoelectric UNDT tests offer many advantages: safety, flexibility, and cost. However, the piezoelectric tests have certain limits, namely: the need to use a coupling; and the need to have a good surface condition. They require mechanical contact between the tested parts and the probes. During the testing of hot parts, the difficulty of finding a suitable coupling for UNDT piezoelectric tests increases with temperature. In general, the piezoelectric UNDT tests cannot be conducted above 100° C.

The main aspect of the prior art of the invention relates to electromagnetic acoustic transducers (EMAT). Among the UNDT technologies, the EMAT method is based on a magnetic coupling mechanism. The sound waves are generated in the material, and not by contact with the surface of the material of the tested parts. The EMATs offer high advantages over conventional piezoelectric transducers. An EMAT may generate and receive different wave modes in conductive and ferromagnetic materials, without physical contact or liquid coupling with the tested parts. Such contactless and non-coupling functionalities increase the reliability of the test. Because the physical properties of the transmission path do not change. Furthermore, the required tolerance specifications for the position and propulsion of the parts, tested in front of the EMAT probes, are flexible. This makes the conventional EMATs well suited for industrial applications involving an average inspection temperature (up to 600° C.), and poor surface conditions of the parts tested in motion.

There are two main components in an EMAT. One is a magnet, and the other is an HF electrical coil. The magnet may be a permanent magnet or an electromagnet, which produces a static or quasi-static magnetic field. The electrical coil (or electrical circuit) is traversed by an HF current. It emits or it is induced by a high-frequency magnetic field. The EMAT phenomenon is reversible. Consequently, the same EMAT probe can be used either as an ultrasound emitter in an inspected material, or as an ultrasound receiver for an ultrasonic signal emitted by an inspected material, or in a combination of the two operating modes. The prior art uses EMATs in a wide range of applications, including for measuring the thickness of metal products, detecting pipeline defects, detecting defects in rails, detecting defects in steel products, etc.

It is known by the prior art to attach a wear plate to an EMAT, to protect the magnet and the electrical coil circuit from wear due to the movement of the EMAT facing the inspected material. The wear plate is generally disposed between the inspected material and the active components of the EMAT, including the magnet and the electrical coil circuit. The common wear plates have the drawback of introducing higher reluctance paths between the magnetically active part of the EMAT and the inspected material.

The main challenge of the common EMAT technology is that the EMAT probes suffer from a low magnetic transduction efficiency both for the static magnetic field generated by the magnet(s) and for the HF magnetic field emitted or received. The prior art knows that introducing a magnetic core, made of a material with high permittivity, of ferromagnetic or ferrimagnetic type, between a magnetic emitter and a magnetic receiver, can increase the intensity of the induced magnetic field by hundreds or thousands of times. The magnetic core itself creates a magnetic field which is added to the emitted field. The magnetic field amplification effect depends on the magnetic permittivity of the material of the magnetic core. It is also known that the interposition of a magnetic core may have negative side effects in the case of a variable HF magnetic field, linked to the eddy currents generated in the magnetic core. These cause significant losses of energy, which depend on the frequency of the HF magnetic field. When the magnetic core consists of a single continuous piece, the variable HF magnetic field causes significant eddy currents, arranged according to closed loops of electric current running through the entire section of the magnetic core, deployed perpendicularly to the variable HF magnetic field emitted. The eddy currents running through the magnetic core cause, by the resistance of its material, significant losses of power by Joule effect. This is the reason why, the prior art frequently uses a matrix laminated magnetic core, consisting of a stack of thin active sheets, made of a magnetically active material, of ferromagnetic or ferrimagnetic type, separated by thin insulating passive sheets. The thin insulating passive sheets serve as eddy current barriers. In such a way that the eddy currents can only circulate in narrow loops, perpendicular to the emitted field, in the thickness of each thin magnetically active sheet. Given that the current in an eddy current loop is substantially proportional to the area of its loop, a matrix laminated magnetic core according to the prior art aims to minimize the area of all eddy current loops, which are by nature perpendicular to the emitted HF magnetic field.

In order to overcome the magnetic reluctance, it is known by the prior art document of US Pat. No. 7,546,770 B2 to include, in an EMAT, a matrix laminated magnetic core, constituted in the form of a sandwich matrix, comprising a multitude of thin ferromagnetic laminated sheets arranged in layers. Thin insulating sheets are sandwiched between thin ferromagnetic sheets, to constitute the sandwich matrix of the matrix laminated magnetic core. The EMAT is described specifically and exclusively in a configuration in which the HF electrical coil is configured to induce eddy currents at the surface of the inspected material, and not to receive it. It should therefore be noted that this prior art relates and describes a probe configured as an EMAT transmitter only, and not as a receiver. The laminated magnetic core is arranged between the magnet and the inspected material. It is not arranged directly opposite the HF electrical coil. The entire outer surface of the laminated magnetic core is covered with a continuous conductive layer made of an electrically conductive material. It is known that an electric coil having the shape of a coil, and powered by an electric current, produces a bundle of magnetic field lines, consisting of a multitude of magnetic field loops parallel to the axis of the circular whorl passing through the interior of the coil. The absolute intensity of each magnetic field loop is variable. It depends on its point of passage and on its distance from the centre of the coil. It is also known that an alternating HF magnetic field loop produces eddy currents on a material placed in the vicinity of its centre, the direction of which is substantially perpendicular to the HF magnetic field loop. Consequently, and although this is in no way described in this prior art, it will be understood that when this EMAT operates in HF emission mode, in turn its electrical coil generates, in the direction of the magnetic core, a multitude of alternating HF magnetic field loops, of variable absolute intensities, passing through the center of the whorl. The axis of the electrical coil described is substantially parallel to the stacking plane of the thin sheets. The alternating HF magnetic field loops are therefore substantially parallel to the stacking plane of the thin sheets of the laminated magnetic core. This therefore induces a multitude of induced current loops, distributed only on the surface of the continuous conductive layer which completely envelops the laminated magnetic core. These induced current loops are topologically distributed on the surface of the conductive layer in an inhomogeneous, non-organized, continuous, and a non-discrete manner. They have an absolute intensity which is variable and inhomogeneous, depending on their position on the continuous conductive layer. They are oriented substantially perpendicularly to the stacking plane of the thin sheets. The current loops induced on the surface of the conductive layer are therefore substantially perpendicular to the ferromagnetic laminated thin sheets. As a result, no ferromagnetic laminated thin sheet is encircled at its periphery by an induced current loop. The current loops induced on the surface of the conductive layer are mostly parallel to the surface of the inspected object.

The laminated magnetic core of this prior art offers mechanical protection of the magnet and of the high frequency HF electrical coil. It also provides an improved transmission of the static magnetic flux from the magnet to the inspected material. This laminated magnetic core provides a high frequency, global but low, blur and topologically non-homogeneous coupling of the HF magnetic field, between the HF electric coil and the eddy currents at the surface of the inspected material facing the probe and the HF electric coil. The coupling of this HF magnetic field is done globally and in-homogeneously, by the outer continuous conductive layer, and not selectively and/or locally by each of the inner thin ferromagnetic laminated sheets.

According to this prior art, the HF electrical coil is arranged over the magnet, at a large distance from the laminated magnetic core and from the inspected material. In such an arrangement of the magnet, additional losses are generated during the transmission of the HF electromagnetic energy, between the HF electrical coil and the inspected material. This arrangement of the laminated magnetic core of an EMAT minimizes the flux leakage of the static magnetic field generated by the magnet. However, it degrades the quality of the coupling of the HF magnetic field between the eddy currents at the surface of the inspected material facing the probe and the HF electrical coil of the EMAT. This HF magnetic coupling is of inhomogeneous intensity between, on the one hand, the various local active fractions of the material facing each of the edges of each ferromagnetic laminated thin sheet and, on the other hand, the HF electrical coil.

According to this prior art, the laminated magnetic core is thermodynamically passive. It does not include any active cooling means that could actively extract a portion of the heat energy generated by the current loops induced at the surface of the perimeter of the ferromagnetic laminated thin sheets of the magnetic core. This EMAT, which is not actively thermally protected, cannot operate in a sustainable way and in a reliable manner at temperatures above 600° C.

In a conventional EMAT, such protection of the active parts is ensured by an electromagnetically passive protective plate made of an insulating material, fixed on the working side of the transducer, making distant its active parts from the inspected material. The thickness of this protective plate is the result of a compromise between the mechanical resistance, the required operating temperature, and the efficiency of the transduction of the EMAT.

The prior art also offers EMATs equipped with hollowed and non-laminated passive magnetic cores. These magnetic cores are either equipped or not equipped with cooling means, for a high-temperature operation. However, these EMATs of the prior art do not combine a laminated magmatic core and cooling means internal to such a laminated core, and they do not optimize and do not homogenize the HF magnetic coupling and/or do not effectively minimize the leakage of flux of the HF magnetic field between the HF electrical coil and the inspected material.

The reception of ultrasonic signals by an EMAT operating in reception mode, operates in the same manner as an EMAT operating in emission mode. The receiving direction of the EMAT operating in the receiving mode can be easily and purely electronically modified. This directivity makes it possible to achieve a high signal-to-noise ratio of an EMAT operating in reception mode.

There has been a very limited operation of the EMATs of the prior art, for inspection in a difficult industrial environment and/or under conditions of high temperature higher than 1000° C., in order to perform a scanning by continuous and mobile in-line scanning, of large areas of movable structures in the form of a plate from a single place, in a manner similar to that used at low temperature in the inspection of the pipes and of the rails.

A second aspect of the prior art relates to Laser-EMAT UNDT technology, which improves the overall sensitivity of UNDT systems using an EMAT, and their adaptability to operate at average temperatures ranging up to 600° C. The UNDT phenomenon needs an ultrasound generator and an ultrasound receiver.

A common Laser-EMAT system combines both an ultrasound generator made of a high-power pulse laser, and an EMAT operating in reception mode as an ultrasound receiver. The prior art describes such UNDT combined devices for detecting surface and subsurface discontinuities in a structure. They are based on the joint operation of i) an ultrasonic transmitter made of a pulsed laser directing a laser beam towards the structure at an emission point, and generating ultrasonic surface waves and shear waves in the structure, when the radiation of the pulsed laser beam is absorbed by the structure; and ii) an ultrasonic receiver made of an EMAT acting in reception mode, detecting the ultrasonic surface waves and/or the shear waves at a detection point. When a high energy density laser beam is drawn to the surface of the material of a component under test, such as a steel slab, the local pulse causes rapid heating, which leads to the explosion of a plasma at the surface of the component. Such an explosion generates ultrasonic waves throughout the material of the component. The Laser generates two distinct types of waves in the material. One is propagated on or near the surface of the component. This is the most significant detectable signal, which propagates transversely to the surface of the component. The other is propagated deeply at a wide angle in the majority of the material of the component. When the material of the component is conductive, the ultrasonic EMAT receiver of the Laser-EMAT system is used to detect the ultrasonic signal generated in the tested material, by the combination of the effects of its HF electrical coil and its magnet. The vibrations at the surface and inside the material, initiated by the ultrasonic signal produced by the Laser, and influenced by the echoes of the discontinuities of the material and by their locations, induce an HF electrical current in the detection circuit of the ultrasonic EMAT receiver, via eddy currents generated in the inspected material. The surface and internal discontinuities of the component, situated between the laser impact and the EMAT ultrasound receiver, can thus be detected and located by processing the signal of the current in the HF electrical coil, by identifying the changes and disturbances in the received ultrasonic signal caused by the discontinuities in the inspected material.

These combined UNDT devices show a better efficiency in the detection of discontinuities than EMAT devices alone, which are based on EMATs used both in transmitter mode and in receiver mode. Because pulsed lasers are more efficient, directional, and powerful as an ultrasonic sound emitter, than conventional EMAT emitters. The main drawback of common Laser-EMAT systems is that they retain the limitations and disadvantages of the common EMAT receiver which they use as a receiver, as indicated above. The laser beam can operate at elevated temperature above 600° C. But the conventional EMATs of the prior art cannot do it.

A third aspect of the prior art of the invention relates to the optimized automatic adjustment of the Dynamic Soft Reduction (DSR) parameters of a continuous casting of steel parts at a temperature of about 1200° C., such cast strands of slabs and/or billets of steel, in the production of a steel mill. The steel slabs are usually subsequently transformed into finished steel products, which include sheets, plates, rolls of strip metal, pipes, and tubes.

During the solidification of the cast steel strand, between the solid phase and the liquid phase of the metal, there is a region inside the slab which is neither completely solid nor liquid. The fraction (percentage) of solid in this “mushy” region depends on the thermal properties and on the composition of the steel. The volume of steel transformed from the liquid into solid shrinks due to the change in density related to the lowering of the temperature of the strand casting. This retraction during solidification leads to voids in the inter-dendritic structure. At the crater of the final solidification region, a central segregation zone occurs. The internal segregation defects, and the porosity at the center of the slab structure, during the continuous steel casting process of the cast strand of the slabs, have an extremely negative effect on the properties of the finished steel products produced subsequently from the slab. This central segregation degrades the quality of steel products, in particular thick steel plates. It gives rise to inconsistent mechanical properties and to a potential failure of the final steel products.

There have been many attempts in the prior art to seek to reduce or detoxify the central segregation of the steel slabs of these defects incurred during continuous casting. A general practice to overcome this problem is to reduce the casting speed. Of course, this affects the overall flow rate of the casting. Another practice of the prior art consists in applying a soft reduction (“Soft Reduction” SR) during the last stage of solidification, and/or a dynamic secondary cooling (DSC). The basic idea of any kind of soft reduction (SR) is to suppress the formation of the central macro-segregation and of the porosity, by compensating the solidification shrinkage and by interrupting the suction flow of the residual steel. The SR operation must be conducted according to a suitable reduction intensity, and to the vertical of the appropriate mushy zone of the final solidification step, using pinch rollers or other similar specialized equipment. The SR can be performed only where the center of the cast strand of the slab is not yet stiff. The optimal point is the end of the solidification zone. The reduction intervals must be located between the two-phase solid-liquid zone and the solidification end of the cast strand of the slabs; in order to improve the density and homogeneity of the center of the strand. The problem is that the exact position of this optimal point of completion of the solidification is variable and unknown, since located at the center of the cast strand of steel slabs and therefore invisible according to the technical means of the prior art.

In the “soft reduction method at the end of solidification” (LSR), a plurality of reduction rollers are arranged at several reduction intervals close to the position of completion of the solidification of the strand, and of the reduction zone of the cast strand of the slab during continuous casting, estimated approximately. The LSR is a method of gradually reducing the generation of the voids in the center of the cast strand and of the molten soft steel stream. Static soft reduction (SSR), provided by the adjustment of the fixed nip rolls gap, was employed by the prior art to improve the internal quality of the continuously cast strand of steel slabs. However, the location of the pinch rollers at fixed reduction intervals is optimized and is applicable only for a precise set of casting parameters. This means that the casting operation must be maintained as stable as possible. The SSR fixed reduction zone imposes a restriction on the overall casting operation. The operational events cause it to be difficult to maintain a steady state of the casting parameters for extended periods of time. Casting parameters such as casting speed and super-heating may change during the casting process. As a result, the solidification range moves during the process. The operational efficiency of the SSR method is low.

In order to have greater operational flexibility, while maintaining good internal quality, the prior art has proposed a dynamic soft reduction (DSR) system, which takes into account the transient casting conditions, the evolutionary solidification processes, and the behaviour of the inspected material. The DSR, combined or not with a dynamic secondary cooling (DSC), was found to be a more efficient means than SSR to minimize segregation and porosity of cast strand of steel slabs. The parameters of the DSR must be carefully defined, in order to effectively eliminate the segregation of the center, and, to improve the internal quality of the cast slabs. It is important to apply the soft reduction to the correct location and with precise spacing of the pinch rollers during the solidification phase. If the DSR takes place too early, the reduction simply deforms the outer faces of the slab and does not penetrate effectively at the centre. Applied too late, the slab is already entirely solid, and the resistance to deformation is too high, which leads to excessively high loads on the rollers of the equipment. The main parameters influencing the reduction, which determine the efficiency of the dynamic soft reduction position DSR, are the format of the slab, the casting speed, the steel composition (thermal properties), the overheating and the cooling rate. In orderto achieve an efficient dynamic soft reduction DSR, it is necessary to dynamically control the spacing of the pinch rollers, and preferably their position, according to the variable actual geometric state of the internal solidification process, given the current and historical conditions of the strand casting.

The precise provision in time: i) of a dynamic 3D mapping (3DM) of the strand of slab being cast, and/or ii) of the 3D location of the central segregation zone of the steel slabs and/or of the position of the segregation defects; provided by a dynamic 3D mapping system (3DMS) of the casting, are the basic requirements for the effective implementation of a dynamic soft reduction DSR and/or for an effective dynamic secondary cooling DSC.

The DSR/DSC systems of the prior art generally comprise the following means:
a. a dynamic 3D mapping system (3DMS) of steel casting;
b. a computerized DSR optimization system (DSRM), generating dynamic DSR optimization parameters (PCSD), based on the dynamic 3D mapping (3DM) provided by the 3DMS system and on the casting parameters;
c. a digital DSR activator (ASR), dynamically adjusting the DSR action parameters (PASD), as a function of the PCSD generated by the DSRM;
d. optionally, a DSC optimization system (DSCM), generating dynamic DSC optimization parameters (PCSC) based on the dynamic 3D mapping (3DM) provided by the 3DMS system and the casting parameters;
e. optionally, a digital DSC activator (ASC), dynamically adjusting the DSC action parameters (PASC) of the water flow rate of the DSC, as a function of the PCSC generated by the DSCM.

The three important parameters of the DSR reduction, such as the position and geometry of the reduction zone, the dynamics and the reduction rate, the value of the spacing of the rollers in the reduction section, must be considered exhaustively in the algorithm of the computerized optimization model DSRM.

The dynamic 3D mapping systems (3DMS) for steel casting of the prior art, operate solely by simulation. They perform:
a. a numerical simulated prediction based on theoretical algorithms; and based on a mathematical model of heat transfer and solidification in the cast strand of slabs; and,
b. not by a physical detection of an actual dynamic 3D mapping (3DM) really observed from the inside of the cast strand of steel slab, with the precise location of the central mushy zone, and the position of the discontinuities in the middle of the cast strand of slab.

A recent variant of a dynamic 3D mapping system for casting steel (3DMS) of the prior art is based in particular on an algorithmic interpretation of the data of a 2D thermal tracking of the outside of the cast strand of slab, by made a system .

None of the dynamic 3D mapping systems (3DMS) for steel casting of the prior art offers an observed accurate and reliable definition of the 3D mapping of the discontinuities in the reduction/solidification zone of the cast strand of slab, and/or of the location of the median mushy zone of the slab and/or of the segregation defects. The parameters of the soft reduction DSR, such as the position and geometry of the reduction zone, the dynamics and the reduction rate, the value of the spacing of the rollers in the reduction section, are adjusted by the prior art on the basis of a predicted information on the basis of a theoretical model, which is not observed, and often delusive, of the central mushy zone and of the state of the discontinuities inside the cast strand of slab. Thus, the DSR and/or DSC parameters are often inappropriate and ineffective in a continuous steel casting machine. They do not make it possible to effectively adjust, by a dynamic soft reduction and/or a secondary dynamic cooling appropriately adjusted, the segregation and the excessive porosity of the center of the cast strand of slabs during the solidification process.

### TECHNICAL PROBLEM

It emerges from the analysis of the prior art above that another approach is necessary to solve, among other things, the following technical problem of the Ultrasonic Non-Destructive Control (UNDT):
a. Offering in a single EMAT probe a combined solution to the following three technical problems:
   i. increasing the transmission of the energy of the HF magnetic field, maximizing the HF magnetic coupling and/or minimizing the leakage of flux of the HF magnetic field, between the electric coil and the eddy currents generated at the surface of the inspected material; and,
   ii. providing a surface topological homogeneity of the efficiency of this high-frequency electromagnetic coupling, between the electric coil and the eddy currents at the surface of the inspected material facing the probe; and,
   iii. having an operating capacity at elevated temperatures of the inspected material greater than 1000° C.
b. Offering in a single UNDT device a combined solution to the following two technical problems:
   i. optimizing the resolution of the detection of surface and deep subsurface discontinuities in a thick metal structure; and,
   ii. having an operating capacity at elevated temperatures of the inspected material greater than 1000° C.
c. Offering a 3D scanner of conductive structures, giving a combined solution to the following two technical problems:
   i. providing a continuous 3D scanning per line of large thick conductive moving structures, such as metallurgical slabs, from a specific location, generating a 3D mapping observed at high resolution of this structure, including by providing the location of the surface and deep under-surface discontinuities; and,
   ii. having capacity to operate in a difficult industrial environment, at elevated temperatures of the inspected material greater than 1000° C.
d. Allowing an optimized automatic adjustment of the DSR action parameters (PASD) of the dynamic soft reduction (DSR) and/or of the DSC action parameters (PASC) of the dynamic secondary cooling (DSC) of a continuous casting of strands of steel slabs in a steel mill, based on the observed state of the inside of the cast slab; by solving in a single apparatus the combination of the following four technical problems:
   i. continuously providing a really observed dynamic 3D mapping (3DM) of the interior of a cast strand of slab;
   ii. continuously defining in a 3D observed manner the location of the central mushy zone of the strand of slab and/or segregation defects, based on a 3D physical observation, and not simply provided by a numerical simulation prediction by a theoretical algorithm based on a mathematical model;
   iii. precisely detecting, the observed position of the point of reduction of the cast strands of slabs, based on a 3D physical observation;
   iv. improving the accuracy and reliability of the automatic adjustment of the parameters of the dynamic soft reduction (DNS) and/or of the dynamic secondary cooling (DSC), of a continuously cast strands of the slabs, at temperatures above 1000° C.; in order to reduce the segregation defects and the porosity in the central mushy zone in fusion of the structure of the strands of steel slabs during the continuous casting process in a steel mill.

### SOLUTION TO PROBLEM

Briefly, in accordance with one aspect of the invention, an Electromagnetic Acoustic Transducer (EMAT) for detecting surface and internal discontinuities in an electrically conductive inspected material is provided; this to offer a technical solution to the technical problem above (a). In a counterintuitive manner for the person skilled in the art, and unlike the conventional configuration of the EMATs of the prior art, using a laminated magnetic core, the technical solution of the invention consists in particular in that:
a. It is not sought to reduce the area of the eddy current loops inside the active HF laminae of the laminated magnetic core. On the contrary, the invention seeks to increase the area and effect of the current loops induced in the (ferromagnetic) active HF laminae; but this in a configuration and an orientation, which are topologically organized in a suitable manner, to take advantage of it in order to improve the efficiency and homogeneity of the coupling, as well as the performance of the EMAT.
b. The EMAT is not configured so that, in the emission mode: i) the alternating HF magnetic field loops induced by the HF electrical coil in the magnetic core are substantially parallel to the stacking plane of the laminated magnetic core thin sheets; and ii) a multitude of induced current loops are distributed only on the surface of a continuous conductive layer which completely envelops the laminated magnetic core and iii) the induced current loops are topologically distributed over the entire surface of the conductive layer in an inhomogeneous, non-organized, continuous and non-discrete manner, and iv) these induced current loops are oriented substantially perpendicular to the stacking plane of the thin sheets. But, on the contrary, according to the invention, the EMAT is configured so that in emission mode: i) the alternating magnetic field loops HF induced by the HF electrical coil in the magnetic core are substantially perpendicular to the stacking plane of the thin sheets of the laminated magnetic core; and ii) the inducted loops of currents are positioned only on the periphery of the active HF laminae and are oriented in a plane parallel to the plane of the active HF laminae that they encircle on their peripheries, and they are therefore perpendicular to the surface of the inspected object; and iii) the induced current loops are topologically distributed discretely and distant, but in an homogeneous way over the periphery of the active HF laminae; and iv) these induced current loops are thus oriented substantially parallel to the stacking plane of the thin sheets.
c. The EMAT is not configured so that the active HF laminae consist of a solid-shaped sheet. On the contrary, according to the invention, the active HF laminae are pierced at their centers, by a via-hole, around which rotates, perpendicular to its axis, a current loop induced on the periphery of each active HF lamina.
d. The EMAT is not configured with an electrical HF coil made of a coiled circuit, distant from the laminated magnetic core, and separated from the magnetic core by a magnet, emitting in emission mode a variable HF magnetic field flux of inhomogeneous absolute intensity on a continuous conductive layer surrounding all the active HF Laminae of the magnetic core. But on the contrary, and in contrast, according to the invention, the EMAT is configured with an electrical coil made of a HF meander-circuit composed of a succession of parallel portions of electrical conductors. The magnetic core is not covered by a continuous conductive layer. Each electrical conductor portion is traversed by an electrical current of similar absolute intensity but in the opposite direction to the neighbouring electrical conductor portion. The electrical conductor portions are alternately superposed directly above and on the upper edge of each active HF lamina of the laminated magnetic core. In emission mode, the electrical coil HF thus emits a variable magnetic field flux HF of equivalent intensity in each active HF lamina, and which is perpendicular thereto.
e. According to the invention, in emission mode, the adjacent active HF laminae are surrounded by induced current loops rotating in the opposite direction. Thus, in the successive portions of frontal areas of the surface of the material facing each of the active HF Laminae of the laminated magnetic core, an HF variable magnetic field flux of opposite directions for each active HF lamina is induced, but of quasi-equal absolute intensity in each frontal zone facing an adjacent active HF lamina. Thus an eddy current matrix is inducted, on the surface of the inspected material facing the laminated magnetic core, formed of parallel vectors, of substantially equal intensities, but of opposite directions. This constructed topological configuration leads to a greater resolution of the EMAT.

### SUMMARY OF INVENTION

The EMAT comprises:
a. At least one Magnet or an electromagnet, configured to generate a static or quasi-Static Magnetic Field in the Inspected Material;
b. At least one HF Electric Coil (or electric circuit) operating at high frequency, the latter being either configured either as an HF Electromagnetic Transmitter of an Emitted HF Electromagnetic Field if the EMAT is used in Emission Mode, and/or, is configured as an HF Electromagnetic Receiver of an Emitted HF Electromagnetic Field if the EMAT is used in Reception Mode;
c. At least one Perforated Matrix Laminated Magnetic Core, configured to concentrate and direct an Emitted HF Electromagnetic Field; made of the type comprising a (sandwich ) Matrix consisting of a multitude of laminated Thin Sheets, stacked periodically along the Matrix Axis.

The sandwich Matrix comprises a First Multitude of HF Active Laminae. They are isolated from one another. They internally incorporate a Magnetic Material with high magnetic permeability. Each of those HF Active Laminae, either externally integrates an electrically conductive material; and/or is covered externally with an electrically conductive layer on its Peripheral Edges. A Grooved Cylindrical Aperture passes through each Thin Sheet of the Matrix and opens onto each of the two lateral Matrix Faces. A multitude of Magnetic Via-Holes, of similar dimensions and cross-section, and with a closed lateral perimeter, are perforated through and substantially at the center of each of the multiple HF Active Laminae of the Matrix. They are aligned to form by their alignment the Grooved Cylindrical Opening. A multitude of Induced Current Loops are generated in the HF Active Laminae.

The particularity of this EMAT lies in the combination of the following technical means. Each Magnetic Via-Hole, made in each apertured HF Active Lamina, is located between the First Edge Face facing the Inspected Surface, and the Second Edge Face facing the HF Electric Coil. Each Magnetic Via-Hole of the Grooved Cylindrical Aperture is internally free of any hard material; and is free of any electrical conductor passing through it. When the EMAT is in operation, the Induced Current Loops are induced within the Active Lamina Skin on the Peripheral Edges of HF Active Laminae, are substantially parallel, and separated from one another. They encircle the Magnetic Via-Holes of their HF Active Lamina and rotate around it.

In a variant embodiment of the invention, a Laser-EMAT probe (LEMAT), for inspecting an Inspected Material, by receiving an ultrasonic signal emitted from this Inspected Material, is presented; in order to offer a technical solution to the technical problem above (b).

This LEMAT comprises:
a. An EMAT according to the invention, as set forth above, configured in Reception Mode, for receiving an ultrasonic signal from the Inspected Material; and
b. A Laser Source configured to drawing a high energy Laser Beam at a Firing Point of the surface of the Inspected Material.

The Laser Source generates ultrasonic waves producing Primary Ultrasonic Waves, propagating on the surface and/or inside and in depth of the Inspected Material. This generates Secondary Ultrasonic Waves resulting from the echoes of the interactions with the discontinuities located on and/or inside the Inspected Material and depending on their locations, propagating on the surface and/or inside the Inspected Material. This generates Material Eddy Currents on the Inspected Material, induced by the Secondary Ultrasonic Waves, under the influence of the Static Magnetic Field emitted by the Magnet of the EMAT. This in turn induces an Emitted HF Electromagnetic Field, emitted by the Material Eddy Currents in the Inspected Material, which is representative of the topography of the surface and internal Discontinuities of the Inspected Material.

In another embodiment of the invention, a Multi-Laser-EMAT 3D scanner (MLEMAT) is presented for the detection of Discontinuities on and inside a mobile cylindrical Conductive Structure; in order to offer a technical solution to the technical problem above (c).

The MLMAT comprises:
a. A Conductive Structure to be 3D scanned;
b. A Chassis Frame configured to surround the Conductive Structure;
c. A multitude of Laser-EMAT probes (LEMAT) according to the invention, as indicated above, fixed on the Chassis Frame, positioned, and configured such that, each of the active First Edge Faces of each of their Perforated Matrix Laminated Magnetic Cores, faces the Conductive Structure; and,
d. Displacement Means configured to move linearly the cylindrical Conductive Structure relative to the Chassis Frame.

The particularity of this MLEMAT lies in the fact that the Apertures Loop, constituted by the virtual line joining the centers of each successive Grooved Cylindrical Aperture of each Perforated Matrix Laminated Magnetic Core of each of the adjacent EMATs of the MLEMAT, encircles the Conductive Structure.

In another embodiment of the invention, an adaptation of the Multi-Laser-EMAT 3D scanner (MLEMAT) according to the invention, as indicated above, is presented for the automatic adjustment of the Dynamic Soft Reduction (DSR) of a continuous casting of a strand of steel slabs, at a casting temperature greater than 1000° C.; and it offers a technical solution to the technical problem above (d).

The strand of steel slab is continuously pushed through a Dynamic Soft Reduction Device (DSRD), to suppress the formation of a macro-segregation and porosities in the Central Mushy Zone inside the strand of Steel Slab, thereby dynamically compensating for the solidification shrinkage and by interrupting the suction flow of the residual molten metal in the strand of Steel Slab. The HF Electric Coils of each EMAT of each Laser-EMAT of the MLEMAT are connected to a Casting Dynamic 3D Mapping System (3DMS). This 3DMS is provided with Analog And Digital Processing Means (MDAN) configured to combine and process the Secondary Ultrasonic Electric Currents emitted in the Electrical Coils of each Laser-EMAT of the MLEMAT, which are induced in each HF Electric Coils of this Laser-EMAT by the Material Eddy Currents in the Frontal Zone of the Inspected Material of the strand of Steel Slab. These Material Eddy Currents result from the interactions of echoes generated by the Laser Sources with the Discontinuities on and inside the Inspected Material in the Frontal Zone of the First Edge Face of this Laser-EMAT. The MDANs combine the Secondary Ultrasonic Electric Currents of each EMAT and generate a Dynamic 3D Mapping (3 DM) of the cast strand of Steel Slab, in the Structure Section of the strand located in the Frame Plane, based on the combination and numerical analysis of these multiple Secondary Ultrasonic Electrical Currents in each Laser-EMAT of the MLEMAT. A DSR Optimization System (DSRM) of the DSR of the cast strand, is connected to the 3DMS. It receives the 3DM of the Steel Slab and digitally generates a set of Dynamic DSR Optimization Parameters (PCSD). A Digital DSR Activator (ASR) is connected to the DSRM. It dynamically adjusts the DSR Action Parameters (PASD), as a function of the PCSD generated by the DSRM.

The particularity of this MLEMAT lies in the following combination of technical means. The Cooling Means of each of its EMATs according to the invention generate a Cooling Flow of a Heat-Transfer Fluid. It is thrust inside each Magnetic Via-Hole and each Spacer Via-Hole of the Grooved Cylindrical Aperture of each Perforated Matrix Laminated Magnetic Core of each adjacent EMAT of the MLEMAT, at a Cooling Temperature (TF) markedly lower (by at least 50° C.) than the Curie Temperature (TC) of the Magnetic Material of the apertured HF Active Laminae. Thus, the Dynamic Soft Reduction (DSR) and/or Dynamic Secondary Cooling (DSC) are automatically dynamically adjusted, at a casting temperature greater than 1000° C.

### BRIEF DESCRIPTION OF DRAWINGS

These features, aspects, and advantages of the present invention, as well as others, will be better understood when the following detailed description will be read with reference to the appended drawings, in which similar characters represent identical parts throughout the drawings, in which:

[FIG. 1] is a schematic perspective representation of an EMAT transducer of the invention.

[FIG. 2] is a schematic sectional representation of an EMAT transducer of the invention.

[FIG. 3] is a schematic perspective showing the mode of operation of one of the HF Active Laminae in the Perforated Matrix Laminated Magnetic Core of an EMAT transducer of the invention, used in Emission Mode.

[FIG. 4] is a schematic perspective showing the mode of operation of one of the HF Active Laminae in the Perforated Matrix Laminated Magnetic Core of an EMAT transducer of the invention, used in Reception Mode.

[FIG. 5] is a schematic perspective showing the Perforated Matrix Laminated Magnetic Core of an EMAT transducer of the invention, consisting of the stacking of its HF Active Laminae and its Passive Laminae.

[FIG. 6] is a partial schematic perspective view of the electromagnetic operation of the HF Active Laminae of the Perforated Matrix Laminated Magnetic Core of an EMAT transducer of the invention, used in Emission Mode.

[FIG. 7] is a schematic perspective of an alternative embodiment of some of the Thin Sheets of the Perforated Matrix Laminated Magnetic Core of an EMAT transducer of the invention, to dynamically lift its Perforated Matrix Laminated Magnetic Core out of the Inspected Material.

[FIG. 8] is a schematic sectional view of a Laser-EMAT probe (LEMAT) according to the invention.

[FIG. 9] is a schematic side view of a Multi Laser-EMAT 3D Scanner (MLEMAT) according to the invention.

FIG. 10] is a schematic cross-section perspective of a Multi Laser-EMAT 3D Scanner (MLEMAT) according to the invention, for the automatic adjustment of the Dynamic Soft Reduction (DSR) and/or of the Dynamic Secondary Cooling (DSC) of a continuous casting of molten Steel Slabs, displayed at the level its EMAT probes.

[FIG. 11] is a schematic cross-section perspective of a Multi Laser-EMAT 3D Scanner (MLEMAT) according to the invention, for the automatic adjustment of the Dynamic Soft Reduction (DSR) and/or of the Dynamic Secondary Cooling (DSC) of a continuous casting of molten Steel Slabs, displayed at the level its Laser sources.

[FIG. 12] is a functional block diagram of a Multi Laser-EMAT 3D Scanner (MLEMAT) according to the invention, for the automatic adjustment of the Dynamic Soft Reduction (DSR) and/or Dynamic Secondary Cooling (DSC) of a continuous cast strand of molten Steel Slabs.

### DESCRIPTION OF EMBODIMENTS

The embodiments described below are generally directed to an improved EMAT system (1), which may be used for the Non-Destructive Control (NDT) of a Conductive Structure (90) at a temperature greater than 1000° C.

Referring to [FIG. 1] and to [FIG. 3], we see an Electromagnetic Acoustic Transducer (EMAT) (1) for the detection of surface and internal Discontinuities (2) in an electrically conductive Inspected Material (3). Two Magnets (4) are configured to generate a static or quasi-Static Magnetic Field (SMF) in the Inspected Material (3). It is understood that each Magnet (4) could be replaced by an electromagnet. An HF Electric Coil (6) (or electrical circuit) is placed directly above a Perforated Matrix Laminated Magnetic Core (22). Its Winding Plan (7) (or circuit plane) is parallel to the local Inspected Surface (8) of the Inspected Material (3) facing the EMAT (1). The two Magnets (4) are positioned on each side of the Perforated Matrix Laminated Magnetic Core (22).

Referring to [FIG. 3], it is observed that the EMAT (1) can be used in Emission Mode (EM). The HF Electric Coil (6) is configured as an HF Electromagnetic Transmitter (9) of an Emitted HF Electro-Magnetic Field (HFEMF). It is connected to the output of at least one AC Current Source (11), driving in the HF Electric Coil (6) an HF Alternating Current (AC) at ultrasonic frequency. This induces the Emitted HF Electromagnetic Field (HFEMF) in the direction of the Inspected Material (3). The Emitted HF Electro-Magnetic Field (HFEMF) produces Material Eddy Currents (14) on the surface of the Inspected Material (3). This generates Lorentz Forces (15) at ultrasonic frequency in the Inspected Material (3), by the interaction of the Material Eddy Currents (14) with the Static Magnetic Field (SMF). This can also generate magnetostriction if the Inspected Material (3) is ferrimagnetic. The disturbance of the Lorentz Forces (15) generates Primary Ultrasonic Waves (17) directly in the Inspected Material (3).

Referring to [FIG. 4], it will be understood that the EMAT (1) can also be used in Reception Mode (RM). The HF Electric Coil (6) is then configured as an HF Electromagnetic Receiver (18). It is traversed by a Secondary Ultrasonic Electric Current (19) at ultrasonic frequency. This HF current consists of Secondary Ultrasonic Electrical Signals (88) generated by an Emitted HF Electromagnetic Field (HFEMF) induced by the Material Eddy Currents (14). These Material Eddy Currents (14) are produced on the Inspected Surface (8) of the Inspected Material (3) by Secondary Ultrasonic Waves (21), under the influence of an external ultrasonic source, and interacting with the Static Magnetic Field (SMF). These Material Eddy Currents (14) are representative of the surface and internal Discontinuities (2) of the Inspected Material (3).

Referring again to [FIG. 1] and to [FIG. 2], we see that a Perforated Matrix Laminated Magnetic Core (22) is positioned between the Inspected Surface (8) of the Inspected Material (3) and the HF Electric Coil (6), which directly faces it. The Perforated Matrix Laminated Magnetic Core (22) is configured to concentrate and direct the Emitted HF Electromagnetic Field (HFEMF) in the direction and/or coming from the Inspected Material (3), depending on whether the mode of use of the EMAT (1) is in transmission or in reception. It is of the type comprising a sandwich Matrix (23) consisting of a multitude of laminated Thin Sheets (24). They are stacked periodically along the Matrix Axis (25), between the two main Matrix Faces (26) of the Matrix (23), parallel to its Stacking Plan (27). The Perforated Matrix Laminated Magnetic Core (22) presents multiple Edge Faces (35) with lateral adjacent grooves, extending substantially perpendicular to the Stacking Plan (27) and parallel to the Matrix Axis (25).

Referring to [FIG. 2], we see that one of the Edge Faces (35), namely the First Edge Face (36) of the Matrix (23), faces the Inspected Surface (8) of the Inspected Material (3). The other face, namely the Second Edge Face (37) of the Matrix (23), is situated substantially opposite the First Edge Face (36) and faces the HF Electric Coil (6).

Referring to [FIG. 1] and to [FIG. 5], we see that each laminated Thin Sheet (24) of the Matrix (23) has a spatial geometry and lateral dimensions similar to those of the adjacent Thin Sheets (24) in the Matrix (23). They have two main lateral Sheet Surfaces (32), each parallel to the Stacking Plan (27).

Referring again to [FIG. 1] and to [FIG. 5], it can be seen that the combined successive adjacent Peripheral Edges (33) of each Thin Sheet (24) form a grooved Edge Surface (34) of the Matrix (23) surrounding the Matrix Axis (25). The Core Axis (38) of the Matrix (23) substantially joins the centers of the First Edge Face (36) and the Second Edge Face (37). It is positioned substantially perpendicular to the Matrix Axis (25).

Referring to [FIG. 5] and to [FIG. 6], it will be seen that the Matrix (23) comprises a First Multitude (28) of HF Active Laminae (29) (four are shown in the figures), or of groups of such laminae. Each HF Active Lamina (29) is isolated from the others. It incorporates internally a magnetic material (in particular ferromagnetic or ferrimagnetic) with high magnetic permeability. The magnetic material has a certain Curie Temperature (TC). It externally incorporates an electrically conductive material. It can alternatively be covered externally with an electrically conductive layer on its Peripheral Edges (33). A Grooved Cylindrical Aperture (39) passes through each Thin Sheet (24) of the Matrix (23), along an Aperture Axis (40) of the Matrix (23), substantially parallel to the Matrix Axis (25) and perpendicular to the Core Axis (38). It opens onto each of the two Matrix Faces (26). A multitude of Magnetic Via-Holes (41), of similar cross-sectional dimensions and with a closed perimeter, are perforated through and substantially at the centre of each of the multiple HF Active Laminae (29) thus hollowed out of the Matrix (23), along an axis substantially parallel to the Inspected Surface (8). They are aligned along an axis parallel to the Inspected Surface (8) to form by their alignment the Grooved Cylindrical Aperture (39). They have a Via-Hole’s Longitudinal Envelope (42), disposed along the Aperture Axis (40) of the Matrix (23), the lateral perimeter of which is closed . Referring to [FIG. 3] and to [FIG. 4], it can be seen that when the EMAT (1) is in operation, a multitude of closed Induced Current Loops (43) are induced by the Emitted HF Electromagnetic Field (HFEMF). The later is either emitted by the HF Alternating Current (AC) at ultrasonic frequency in the HF Electric Coil (6) when the EMAT is in emission mode as shown in [FIG. 3]; and/or is emitted by the ultrasonic frequency Material Eddy Currents (14) in the Inspected Material (3) when the EMAT is in reception mode as shown in [FIG. 4]. The Induced Current Loops (43) are located within the Active Lamina Skin (48) of the periphery of each HF Active Lamina (29) of the Perforated Matrix Laminated Magnetic Core (22). As it appears [FIG. 6] they are arranged according to a Loops Mapping (LM), defining the topology, the distribution, and the relative positions of all the Induced Current Loops (43).

With reference to [FIG. 2], the following features of the EMAT (1) are observed. Each Magnetic Via-Hole (41) in each HF Active Lamina (29) is located between the First Edge Face (36) facing the Inspected Surface (8), and the Second Edge Face (37) facing the HF Electric Coil (6). Each Magnetic Via-Hole (41) of the Grooved Cylindrical Aperture (39) is free internally of any hard material. In particular, it is free of any electrical conductor passing through it. With reference to [FIG. 6] it can be seen that the Loops Mapping (LM) is topologically discrete and consists of a multitude of Induced Current Loops (43) in each HF Active Laminae (29), (or groups of such Active Laminae) distant from each other. With reference to [FIG. 3], it can be seen that the Induced Current Loops (43) (or group of such Loops) are induced inside the Active Lamina Skin (48) on the Peripheral Edges (33) of the HF Active Laminae (29). They are each arranged along a plane of loops parallel to the Stacking Plan (27), and substantially perpendicular to the surface of the Inspected Material (3). They are substantially parallel, and separated from one another, between their respective HF Active Laminae (29). They encircle the Magnetic Via-Hole (41) of their HF Active Lamina (29) and rotate around. With reference to [FIG. 6] it can be seen that each Core Spacing Slice (49) of the Perforated Matrix Laminated Magnetic Core (22) and its surface, located between two adjacent HF Active Laminae (29) (or group), is free of any Induced Current Loops (43), and more generally free of any induced electric current.

Referring to [FIG. 3], it can be seen that the Emitted HF Electro-Magnetic Field (HFEMF), and the Perforated Matrix Laminated Magnetic Core (22) are configured such that, when the EMAT (1) is in operation, the HF Core Magnetic Field (HFIMF) has a significant component of the HF Core Transverse Magnetic Field (MFTHF), which is perpendicular to the Stacking Plan (27), perpendicular to each HF Active Lamina (29), and substantially parallel to the surface of the Inspected Material (3). The HF Magnetic Flux (MFHF) within the Perforated Matrix Laminated Magnetic Core (22) has a large component perpendicular to the Core Axis (38) and parallel to the surface of the Inspected Material (3). And therefore it is not perpendicular to the Inspected Surface (8) of the Inspected Material (3). The closed Induced Current Loops (43) are generated by the HF Core Transverse Magnetic Field (MFTHF) on the Peripheral Edge (33) of each HF Active Lamina (29).

Referring to [FIG. 5] and to [FIG. 6], it is understood that a combined and interactive double physical effect occurs within the Perforated Matrix Laminated Magnetic Core (22). On the one hand, each of the multiple parallel and topologically discrete Induced Current Loops (43) of each apertured HF Active Lamina (29), separately generates a high-frequency magnetic field. This separately and locally increases the discrete and selective high-frequency magnetic coupling between a narrow Local Active Fraction (44) of the Inspected Surface (8) facing its First Edge Face (36), and the HF Electric Coil (6). The parallel Induced Current Loops (43) of the HF Active Lamina (29) participate in the overall reduction of the high-frequency magnetic reluctance of the EMAT (1). On the other hand, the Inner Perimeter (45) of each Magnetic Via-Hole (41) in each HF Active Lamina (29) of the Matrix (23) creates a Heat-Conducting and Convective Surface (46) at the center of its HF Active Lamina (29). This produces an internal Thermal Cooling effect to dissipate a fraction of the local electrical and calorific energy generated by the specific Induced Current Loop (43) of each HF Active Lamina (29). This participates in the improvement of the efficiency of the EMAT (1).

Referring to [FIG. 5], we see the Perforated Matrix Laminated Magnetic Core (22), with its HF Active Laminae (29) separated by Passive Laminae (53). Each apertured HF Active Lamina (29) of the Matrix (23) (or group of such Active Laminae) is separated from its neighbours, at the level of the adjacent Core Spacing Slices (49), by at least one sheet of a Second Multitude (54) of Passive Laminae (53) made of an electrically insulating material. Each Passive Lamina (53) is perforated by a Spacer Via-Hole (57). Each Passive Lamina (53) is positioned and configured such that the Magnetic Via-Holes (41) in the First Multitude (28) of HF Active Laminae (29) of the Matrix (23), as well as the Spacer Via-Holes (57) of the Second Multitude (54) of Passive Laminae (53) of the Matrix (23), are aligned parallel to the Matrix Axis (25). They form by their alignment and their combination the Grooved Cylindrical Aperture (39).

This configuration of the Electromagnetic Acoustic Transducer (EMAT) (1) has the following characteristics. Each Spacer Via-Hole (57) in each Passive Lamina (53) is located between the First Edge Face (36) facing the Inspected Material (3), and the Second Edge Face (37) facing the HF Electrical Coil (6). Each Spacer Via-Hole (57) of the Grooved Cylindrical Aperture (39) is free internally of any hard material. In particular, it is free of any electrical conductor passing through it. It is understood that the inner periphery of each Spacer Via-Hole (57) in each Passive Lamina (53) of the Matrix (23) creates a Heat-Conducting and Convective Surface (46) free and internal to the center of the Passive Lamina (53). This produces an internal Thermal Cooling effect in this Spacer Via-Hole (57) in order to dissipate a fraction of the electrical and calorific energy generated by the Induced Current Loops (43) of the adjacent HF Active Laminae (29). This participates in the improvement of the efficiency of the EMAT (1).

As shown in [FIG. 5], it is recommended by the invention that, for each Passive Lamina (53), the Peripheral Edges (33) of their peripheries are free of any conductive material covering their surfaces. In such a way that the grooved Edge Surface (34) of the Perforated Matrix Laminated Magnetic Core (22), is not covered continuously and/or made of an electrically conductive layer, but on the contrary it consists of alternating edges with edges, made on the one hand of conductive rings around the HF Active Laminae (29) and on the other hand of insulating rings around the Passive Laminae (53).

According to a preferred embodiment of the invention, which appears in [FIG. 5], the Perforated Matrix Laminated Magnetic Core (22) of the EMAT (1) comprises Cooling Means (58). They generate a Cooling Flow (59) of a Heat-Transfer Fluid (60) at a Cooling Temperature (TF). This Cooling Flow (59) is forced to pass through the Grooved Cylindrical Aperture (39) of the Matrix (23). This configuration of the EMAT (1) has the following characteristics. The Cooling Flow (59) is configured to pass successively through one of the Magnetic Via-Holes (41) of the First Multitude (28) and, alternatively, through at least one of the Spacer Via-Holes (57) of the Second Multitude (54). It is bootlicking all of the Hole Wall Surfaces (62) of each successive Magnetic Via-Hole (41) and/or of each Spacer Via-Hole (57) of the Matrix (23). It is understood that this increases the internal thermal cooling effect in each HF Active Lamina (29) of the Matrix (23); each of which being subject to an Induced Current Loop (43) and a heat dissipation. It is recommended by the invention that the Cooling Temperature (TF) of the Cooling Flow (59) is adjusted significantly lower (by at least 50° C.) than the specific Curie Temperature (TC) of the Magnetic Material of each apertured out HF Active Lamina (29).

Referring to [FIG. 7], an advantageous alternative embodiment of the EMAT (1) of the invention is seen. At least one (and preferably a multitude of) Thin Sheet(s) (24) of the Perforated Matrix Laminated Magnetic Core (22) is - either pierced by a Cushion Hole (63); - or provided with a Cushion Notch (64). These openings pass through the Annular Wall (65) formed between their Via-Holes (41, 57), and the portion of their First Edge Face (36) facing the Inspected Material (3), in a direction parallel to the Stacking Plan (27). This creates a Cushion Recess (66) between the Via-Holes (41, 57) of the Thin Sheet (24) and the First Edge Face (36) facing the Inspected Material (3). The Cooling Means (58) are configured to extract a Cushion Fluid Flow (67) from the Cooling Flow (59) passing through the Via-Holes (41, 57). It flows under pressure this extracted Cushion Fluid Flow (67) through the Cushion Recess (66). This creates a Lift Air Cushion (70) between the Perforated Matrix Laminated Magnetic Core (22) and the Inspected Material (3), at the level of the Cushion Recess (66) facing the Inspected Material (3). This lifts the Perforated Matrix Laminated Magnetic Core (22) above the Inspected Material (3) of a Cushion Gap (68). This arrangement is reliable. It provides automatic mechanical adjustment of the Cushion Gap (68). It will be understood that this arrangement considerably reduces the heat energy transferred by conduction between the Inspected Material (3) and the Perforated Matrix Laminated Magnetic Core (22), as well as towards the active parts. This arrangement eliminates friction. It significantly increases the operating time and the availability of the EMAT (1), by limiting the wear between the maintenance phases.

Referring to [FIG. 5], a variant embodiment of the EMAT (1) of the invention is shown. The two external lateral Edge Faces (35) of the two external Thin Sheets situated on the Matrix Faces (26) are either constituted of or covered by (as illustrated) a Conductive Covering Layer (69), of an electrically conductive material. This configuration of the EMAT (1) has the following characteristics. A Via-Hole with transverse dimensions similar to those of the Magnetic Via-Holes (41) is perforated through each of the two Conductive Covering Layers (69). The multiple Thin Sheets (24) and the two Conductive Covering Layers (69) of the Matrix (23) are positioned relative to one another, so that their multiple via-holes are aligned to form, by continuity, the Grooved Cylindrical Aperture (39).

According to a preferred variant of the invention, which is described in [FIG. (5)], the perimeter of each Magnetic Via-Hole (41) formed in each HF Active Lamina(29) is rectangular. The center of each Magnetic Via-Hole (41) is substantially located and centred at the center of gravity of its HF Active Lamina (29). And the perimeter of each Magnetic Via-Hole (41) is positioned substantially at a constant Ring Distance (Rd) from the perimeter of the Peripheral Edges (33) of its HF Active Lamina (29). It is understood that in such configuration, each HF Active Lamina (29) is topologically configured as a rectangular Active Ring (71), thermodynamically cooled from the heating of the Induced Current Loop (43) generated around it.

Referring [FIG. 1] an [FIG. 2], a preferred alternative embodiment of the EMAT (1) of the invention is shown. The Second Edge Face (37) of the Perforated Matrix Laminated Magnetic Core (22) directly faces the HF Electric Coil (6). No Magnet (4) or any other element is positioned between - on one side the Second Edge Face (37) of the Matrix (23) and - on the other side the HF Electric Coil (6).

Referring to [FIG. 6], another preferred embodiment of the EMAT (1) of the invention is seen. The HF Electric Coil (6) and the First Multitude (28) of HF Active Laminae (29) in the Matrix (23) are configured such that: the orientation, the pitch, the size and the shape of each of the Circuit Facing Edges (72) of each HF Active Lamina (29), located in the Second Edge Face (37) of the Matrix (23), and facing the HF Electric Coil (6), are consistent and correlated with the geometric parameters, including the orientation, the pitch, the size and the shape, of the Conductor Fractions (75) of the HF Electric Coil (6) successively facing each of these Circuit Facing Edges (72).

A preferred arrangement of the above configuration appears with reference to [FIG. 3]. It can be seen that the HF Electric Coil (6) has at least one Fraction of Linear Conductor (73). The latter is positioned in proximity to and directly above a Circuit Facing Edge (72). It is tangent, along an axis parallel to this portion close to the perimeter of an HF Active Lamina (29) located in the Second Edge Face (37) of the Matrix (23) facing the HF Electric Coil (6). It can be seen that a particularity of this arrangement of the invention is that the Fraction of Linear Conductor (73) and the Perforated Matrix Laminated Magnetic Core (22) are configured such that, when the EMAT (1) is in operation, an Induced Current Loop (43) is induced in the Active Lamina Skin (48) on the periphery of the HF Active Lamina (29). It surrounds its Magnetic Via-Hole (41). This provides a local selective HF magnetic coupling between, - on the one hand an HF Alternating Current (AC) driven in the Fraction of Linear Conductor (73) extending over and along the perimeter of the HF Active Lamina (29), and, - on the other hand, the Material Eddy Currents (14) generated in the narrow Local Active Fraction (44) of the Inspected Surface (8) facing the HF Active Lamina (29).

It is known that the Emitted HF Electro-Magnetic Field (HFEMF) emitted by a Fraction of Linear Conductor (73), through which an electric current flows, is ortho-radial. Consequently, the lines of the HF Magnetic Flux (MFHF) are substantially made of circles surrounding the Fraction of Linear Conductor (73).

If the EMAT (1) is in the Emission Mode (EM), as described in [FIG. 3]; then the HF Alternating Current (AC) flowing through the Fraction of Linear Conductor (73) produces an ortho-radial magnetic flux organised in a loop, generating a Conductor HF Magnetic Flux Loop (76), creating a HF Core Transverse Magnetic Field (MFTHF), which is substantially perpendicular to the HF Active Lamina (29) facing it. This causes an Induced Current Loop (43) at the surface of the Active Ring (71) of the HF Active Lamina (29). This Induced Current Loop (43) emits in turn a multitude of HF magnetic flux loops which produce Material Eddy Currents (14) which are topologically ordered and all oriented along an axis substantially parallel to the plane of the HF Active Lamina (29) which faces them in the proximity directly above.

It is also known that a circular turn supplied by a current produces a bundle of magnetic field lines, in the form of a multitude of loops of magnetic flux parallel to the axis of the circular turn and passing through its centre.

With reference to [FIG. 4], it will be understood that when the EMAT (1) is used in Reception Mode (RM), then the component of the Material Eddy Currents (14) which is parallel to the Stacking Plan (27), generated at the surface of the material, under the influence of an external ultrasonic source, induce a Material HF Magnetic Flux Loop (77) creating a HF Core Transverse Magnetic Field (MFTHF) substantially perpendicular to the Active Ring (71) of the HF Active Lamina (29) facing these Material Eddy Currents (14). This creates an Induced Current Loop (43) inside its Active Lamina Skin (48). The Induced Current Loop (43) longitudinally surrounding this HF Active Lamina (29) then emits a multitude of HF magnetic flux loops which encircle the Fraction of Linear Conductor (73) which is tangent thereto along an axis parallel to a portion of the perimeter of this HF Active Lamina (29). This inductively generates a Secondary Ultrasonic Electrical Signal (88) that creates an HF Alternating Current (AC) in the Fraction of Linear Conductor (73).

According to a preferred embodiment of the invention which appears in [FIG. 3] and in [FIG. 6], the HF Electric Coil (6) is a Meander Circuit (74). It has a multitude of (at least two) Fraction of Linear Conductor (73) (four are shown in [FIG. 6]). They are parallel and adjacent close to one another. The multitude of these Fractions of Linear Conductor (73) of the Meander Circuit (74) are positioned successively in proximity, and directly above a Circuit Facing Edge (72) of one of the HF Active Laminae (29), located in the Second Edge Face (37) of the Matrix (23) facing the HF Electric Coil (6). They are configured so that the HF Alternating Current (AC) passing successively through each of the parallel and adjacent Fractions of Linear Conductor (73) of the Meander Circuit (74) is oriented in alternating opposite directions. It can be seen that a Conductor HF Magnetic Flux Loop (76) substantially perpendicularly surrounds each Fraction of Linear Conductor (73) of the Meander Circuit (74) and penetrates substantially perpendicularly inside the HF Active Lamina (29) facing it. It can also be seen that this arrangement comprises the following characteristics. The Fractions of Linear Conductor (73) of the Meander Circuit (74) and the Perforated Matrix Laminated Magnetic Core (22) are configured such that when the EMAT (1) is in Emission Mode (EM), two adjacent HF Active Laminae (29), surmounted by two adjacent Fractions of Linear Conductor (73) are traversed in their Active Lamina Skin (48) by two adjacent Induced Current Loops (43). They are each composed of an alternating HF electric current rotating in an opposite Direction Of Rotation (78), around the Aperture Axis (40) passing through their Magnetic Via-Holes (41), one being in the clockwise direction, while the other is in the anticlockwise direction.

Referring to [FIG. 1], it can be seen that the Aperture Depth (Od) of the Grooved Cylindrical Aperture (39) of the Perforated Matrix Laminated Magnetic Core (22), along its Aperture Axis (40), is substantially equal and consistent with a First Transverse Dimension (FTd) of the HF Electric Coil (6) of the EMAT (1). In addition, the grooved Second Edge Face (37) of its Perforated Matrix Laminated Magnetic Core (22), facing the HF Electric Coil (6), has a transverse dimension, in a direction perpendicular to the Aperture Axis (40) of the Sandwich (23), which is substantially equal and consistent with a Second Transverse Dimension (STd) of the HF Electric Coil (6) of the EMAT (1).

According to a preferred embodiment of the invention, which appears in [FIG. 5], the Sheet Geometric Dimensions (79) of the perforated Thin Sheets (24) of the Matrix (23) and the combined geometric dimensions of its Perforated Matrix Laminated Magnetic Core (22) are selected to be decorrelated from the wavelengths of the principal harmonics of the Emitted HF Electromagnetic Field (HFEMF). It is understood that this prevents mechanical resonance of its Perforated Matrix Laminated Magnetic Core (22) at the ultrasonic frequency of operation of the EMAT (1).

According to another preferred embodiment of the invention, the Sheet Geometric Dimensions (79) of the perforated Thin Sheets (24) of its Perforated Matrix Laminated Magnetic Core (22) are chosen in such a way that, at the ultrasonic frequency of operation of the EMAT (1), they are either much smallerthan the wavelengths of the ultrasonic waves generated in these Thin Sheets (24), or substantially equal to an odd number of quarters of the wavelengths of the ultrasonic waves generated in these Thin Sheets (24).

According to another preferred configuration of the invention, described in [FIG. 2], the first grooved First Edge Face (36) of the Perforated Matrix Laminated Magnetic Core (22) facing the Inspected Material (3) and parallel to the Grooved Cylindrical Aperture (39) is either covered by, or covered with an Insulating Layer (81) (as illustrated) made of, an electrically insulating material. One of the sides of the Insulating Layer (81) is arranged facing the Grooved Cylindrical Aperture (39) and covers the edge of the First Edge Face (36), belonging to the perimeter of each of the HF Active Laminae (29).

The EMAT (1) of the invention, and its variants explained above, offer a technical solution to the technical problem (a) above. This EMAT (1) increases the transmission of the energy of the Emitted HF Electro-Magnetic Field (HFEMF). It maximizes the HF magnetic coupling and minimizes the leakage of flux of the Emitted HF Electromagnetic Field (HFEMF), between the HF Electric Coil (6) and the Material Eddy Currents (14) generated at the surface of the Inspected Material (3). It ensures a surface topological homogeneity of the efficiency of this high-frequency electromagnetic coupling between the HF Electric Coil (6) and the Material Eddy Currents(14) of the inspected material facing the transducer. It operates at high temperatures of the Inspected Material (3) greater than 1000° C.

Referring to [FIG. 8], a Laser-EMAT Probe (LEMAT) (82) is seen to inspect an Inspected Material (3) by receiving an ultrasonic signal from this Inspected Material (3). The LEMAT comprises the combination of : i) an Electromagnetic Acoustic Transducer (EMAT) (1) according to the invention as described above, and ii) a Laser Source (84). The EMAT (1) is configured in Reception Mode (RM), for receiving a Secondary Ultrasonic Electrical signal (88) of the Inspected Material (3). The HF Electric Coil (6) is configured as an HF Electromagnetic Receiver (18). As shown in [FIG. 4], this Secondary Ultrasonic Electrical Signal (88) is electrically induced by an Emitted HF Electromagnetic Field (HFEMF) emitted by the Inspected Material (3), generated by the Material Eddy Currents (14), produced in the Inspected Material (3) by the Secondary Ultrasonic Waves (21). These Material Eddy Currents (14) are representative of the surface and/or internal Discontinuities (2) of the Inspected Material (3). As shown in [FIG. 8], the Perforated Matrix Laminated Magnetic Core (22) is located between the HF electric coil (6) of the EMAT (1) and the local surface of the Inspected Material (3). It directly faces the HF Electric Coil (6). It maintains a Protective Spacing (83) between the Inspected Material (3) and the HF Electric Coil (6). It reduces the magnetic reluctance of the EMAT (1). It is actively thermodynamically protected from high temperatures and difficult surface conditions of the Inspected Material (3). The Laser Source (84) is configured for drawing a high energy Laser Beam (85) at a Firing Point (86) of the surface of the Inspected Material (3). The Laser Beam (85) generates Primary Ultrasonic Waves (17) propagating on the surface and/or inside the Inspected Material (3). This causes the generation of Secondary Ultrasonic Waves (21) resulting from the echoes of the interactions of the Primary Ultrasonic Waves (17) with the Discontinuities (2) on and/or inside the Inspected Material (3). These Secondary Ultrasonic Waves (21) propagate on the surface and/or inside the Inspected Material (3). They cause the generation of Material Eddy Currents (14) at the surface of the Inspected Material (3), induced by the mechanical vibrations of the Secondary Ultrasonic Waves (21) under the influence of the Static Magnetic Field (SMF) generated by the Magnet (4) of the EMAT (1). This causes the induction of an Emitted HF Electromagnetic Field HF (HFEMF) emitted by the Material Eddy Currents (14) present on the surface of the Inspected Material (3), representative of the geometry and of the position of the surface and internal Discontinuities (2) of the Inspected Material (3). The treatment of this Emitted HF Electromagnetic Field (HFEMF) through the EMAT (1) generates the Secondary Ultrasonic Electrical Signal (88) in the HF Electric Coil (6).

Referring to [FIG. 4], the EMAT (1) is configured in Reception Mode, it is found that the Laser-EMAT Probe (LEMAT) (82) has the following technical characteristics. A multitude of remote Induced Current Loops (43) are induced, by the Emitted HF Electromagnetic Field (HFEMF) emitted by the Material Eddy Currents (14) in the Inspected Material (3) under the influence of the Laser Source (84), within the Active Lamina Skin (48) on the Peripheral Edges (33) of each HF Active Lamina (29) of the Perforated Matrix Laminated Magnetic Core (22). As shown in [FIG. 6], these Induced Current Loops (43) of each HF Active Lamina (29) (or group) are spaced apart from one another. These Eddy Current Induced Current Loops (43) surround and rotate around the Magnetically Active Ring (71), surrounding the Magnetic Via-Holes (41) of the HF Active Laminae (29). They are located between the First Edge Face (36) facing the Inspected Material (3) and the Second Edge Face (37) facing the HF Electric Coil (6). They are positioned substantially perpendicular to these two Edge Faces (36, 37).

It is understood that in such a LEMAT (82), a combined and interactive double physical effect occurs within the Perforated Matrix Laminated Magnetic Core (22). On the one hand, as appears [FIG. 4], each of the multiple discrete and parallel Induced Current Loops (43) of each apertured HF Active Lamina (29) (or group), separately generates a high-frequency magnetic field. It separately and locally increases the high-frequency magnetic coupling between - a Local Active Fraction (44) of the Inspected Surface (8) facing the First Edge Face (36), - and the HF Electric Coil (6). This homogenizes the high-frequency coupling and participates by mutualisation in the global reduction of the high-frequency magnetic reluctance of the EMAT (1). On the other hand, as appears [FIG. 5], the Inner Perimeter (45) of each Magnetic Via-Hole (41) in each HF Active Lamina (29) of the Matrix (23) creates an internal free Heat-Conducting and Convective Surface (46) at the center of its HF Active Lamina (29). This produces an internal Thermal Cooling effect to dissipate a fraction of the electrical and calorific energy generated by the Induced Current Loop (43) of its specific HF Active Lamina (29). This participates in the improvement of the efficiency of the EMAT (1).

The LEMAT (82) of the invention offers a technical solution to the technical problem (b) above. It optimizes the resolution of the detection of the surface, sub-surface, and deep sub-surface Discontinuities (2) in a thick metal structure. It operates at elevated temperatures of the Inspected Material (3) greater than 1000° C.

Referring to [FIG. 9], a Multi-Laser-EMAT 3D scanner (MLEMAT) (89) is seen, for the detection of surface and/or internal Discontinuities (2) inside a mobile cylindrical Conductive Structure (90). The MLEMAT (89) comprises: a) a Conductive Structure (90) to be 3D scanned; b) a Chassis Frame (93); c) a Probes Multitude (96) made of at least two Laser-EMAT Probes (LEMAT) (82) according to the invention, and d) Displacement Means (97). The 3D scanned Conductive Structure (90) is made of an electrically conductive Inspected Material (3). It has a cylindrical structure generated along a Structure Axis (91), and a substantially constant Structure Section (92). The Chassis Frame (93) is configured to surround the Conductive Structure (90) at a Frame Distance (Fd). Its Frame Plane (95) is substantially perpendicular to the Structure Axis (91) of the Conductive Structure (90). The Displacement Means (97) are configured to move linearly the cylindrical Conductive Structure (90) relative to the Chassis Frame (93), along a Displacement Direction (Md), substantially coincident with the Structure Axis (91).

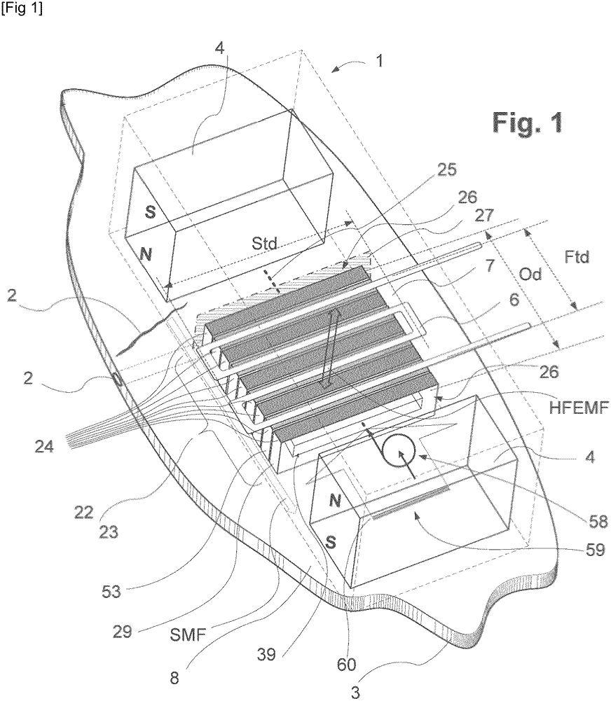

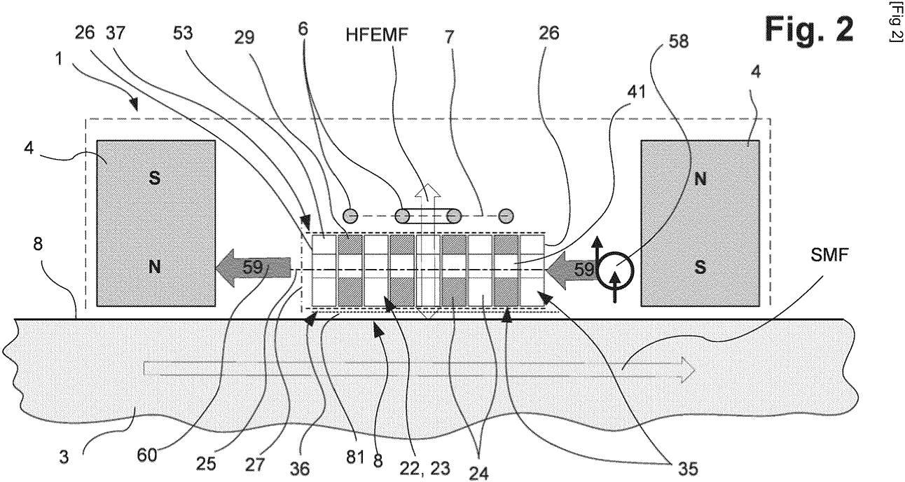

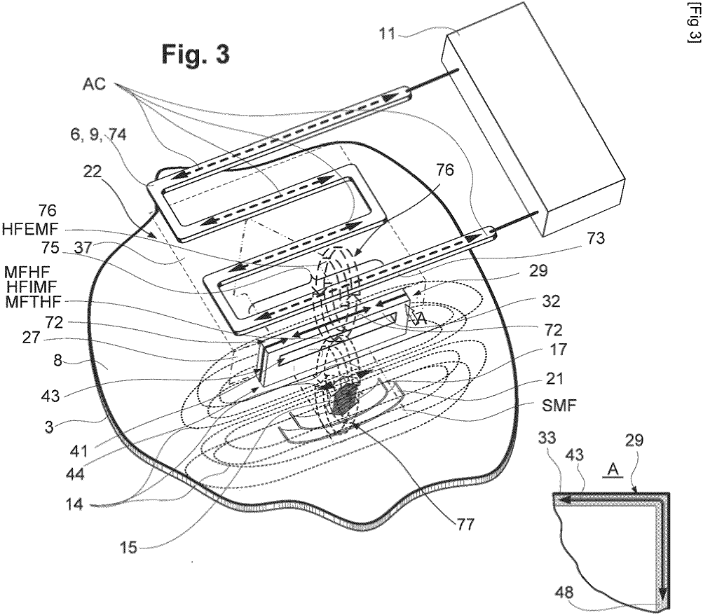

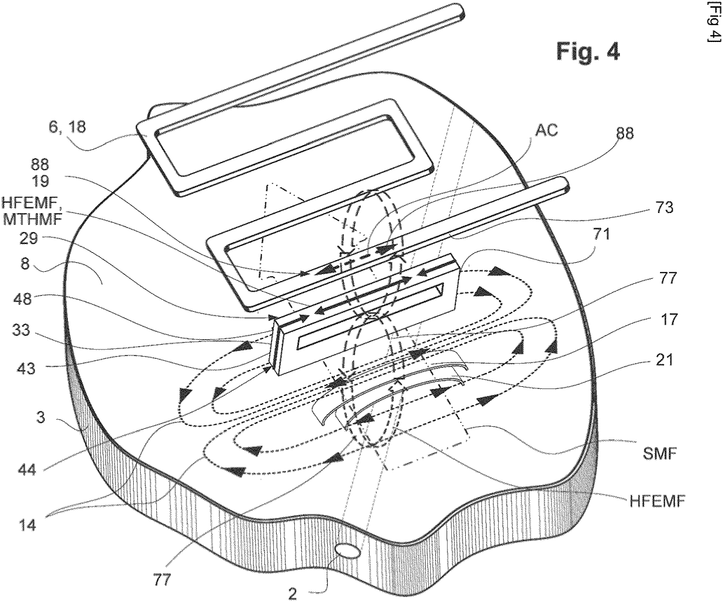

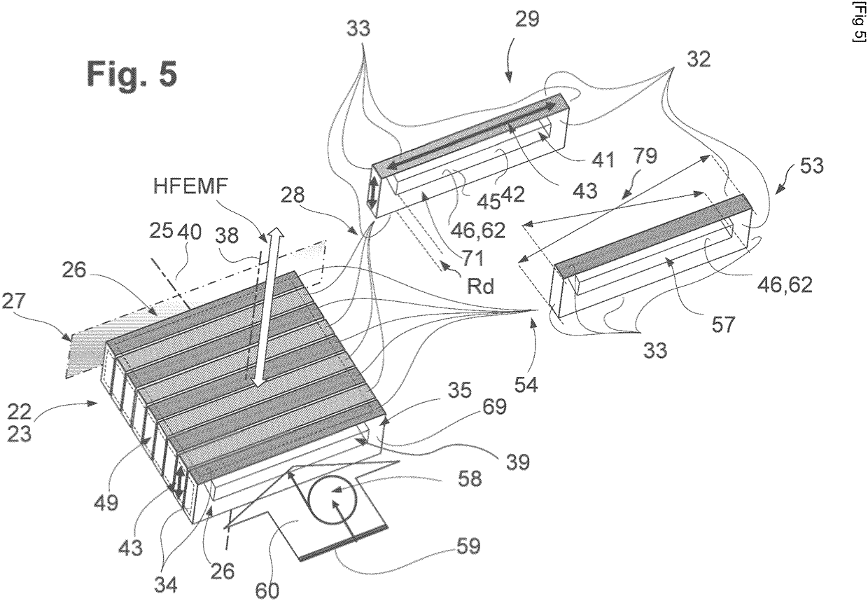

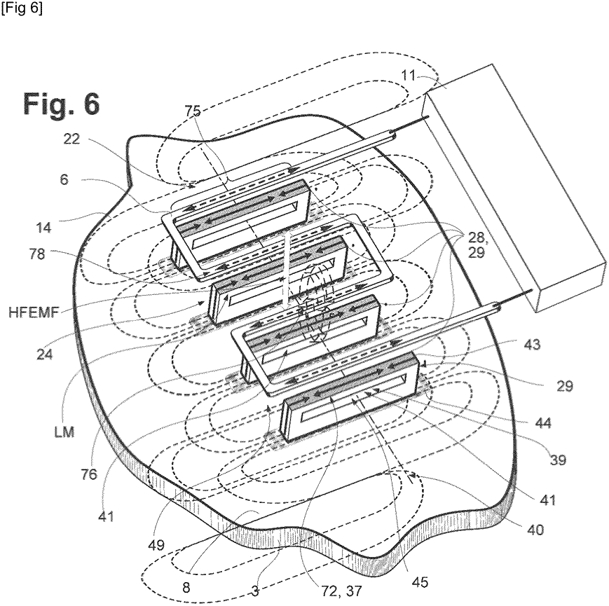

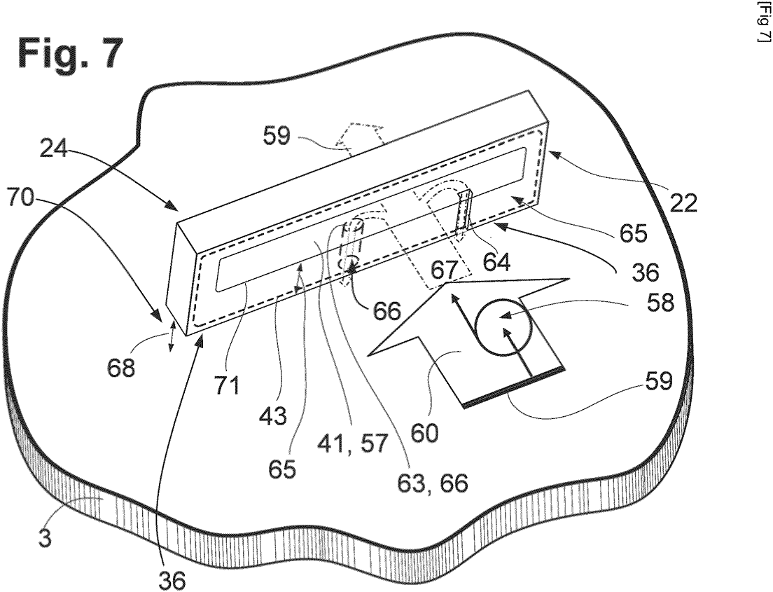

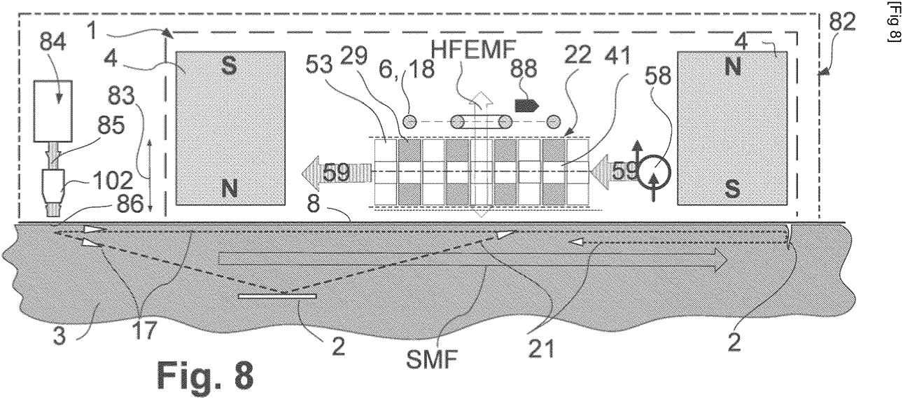

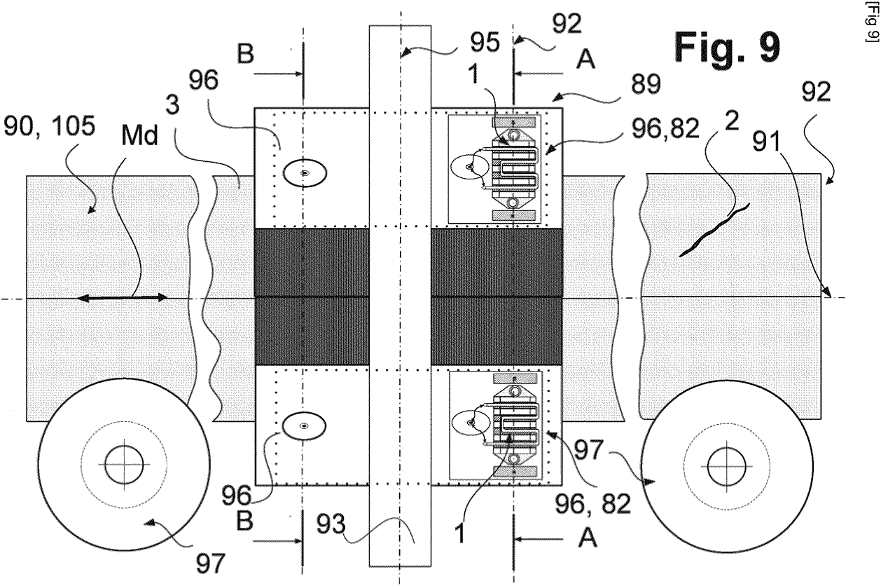

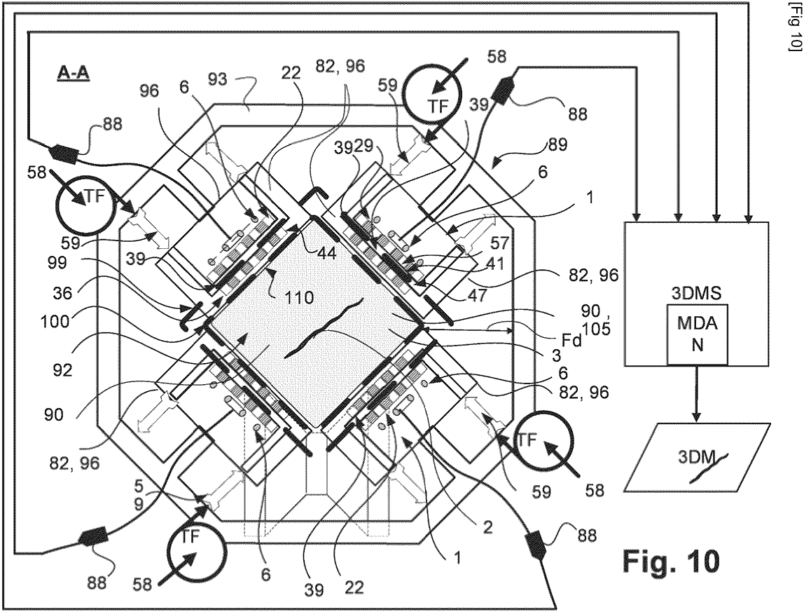

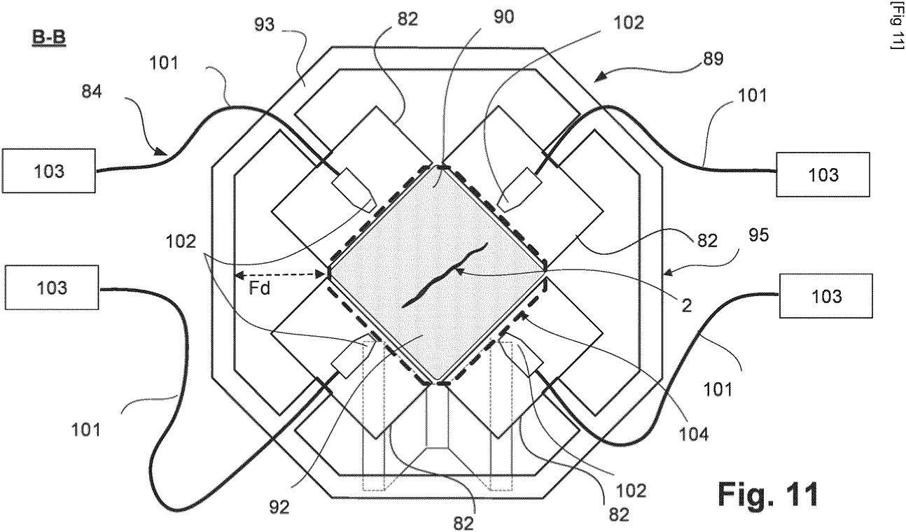

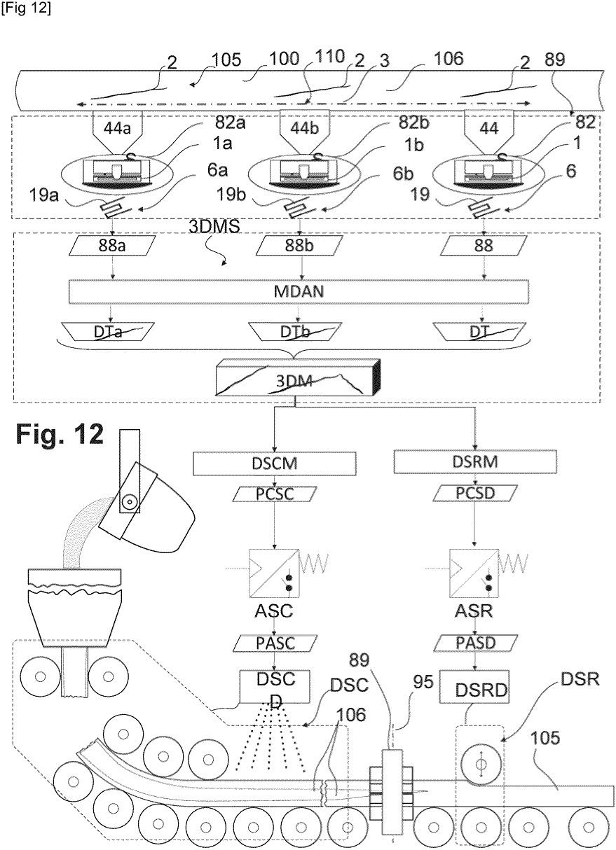

This Multi-Laser-EMAT 3D scanner (MLEMAT) (89) has the following feature that appears with reference to [FIG. 10], the Apertures Loop (99), constituted by the virtual line joining the centers of each successive Grooved Cylindrical Apertures (39) of the Perforated Matrix Laminated Magnetic Core (22) of each adjacent EMAT (1) of the Laser-EMAT Probe (LEMAT) (82) of the MLEMAT (89), encircles the Conductive Structure (90).

It is also seen that the Probes Multitude (96) made of Laser-EMAT Probes (82) are fixed on the Chassis Frame (93), positioned and configured in such a position that the juxtaposition of the multitude of adjacent First Edge Faces (36) neighbouring the Perforated Matrix Laminated Magnetic Cores (22) of each of the adjacent Laser-EMAT Probes (LEMAT) (82), facing the Inspected Material (3), are substantially contiguous with each other, and it constitutes a substantially continuous grooved Inspection Ring (100). This grooved Inspection Ring (100) surrounds and covers the perimeter of the Conductive Structure (90), in a Structure Section (92) of the Conductive Structure (90) close to the Frame Plane (95).

In a preferred embodiment of the Multi-Laser-EMAT 3D scanner (MLEMAT) (89), which appears with reference to [FIG. 11], the Laser Source (84) of each MLEMAT (82) consists of an Optical Fibre (101), fixed to the Frame Plane (95), having a Firing End (102) facing the Conductive Structure (90). Each Optical Fibre (101) is connected to a Laser Generator (103). This configuration of the Multi-Laser-EMAT 3D scanner (MLEMAT) (89) has the following characteristic. The Laser Firing Loop (104), constituted by the virtual line joining the Firing Ends (102) of each adjacent Laser-EMAT Probe (LEMAT) (82) of the MLEMAT (89), encircles the Conductive Structure (90) and is substantially parallel to the Apertures Loop (99).

In a preferred alternative embodiment of the Multi-Laser-EMAT 3D scanner (MLEMAT) (89) of the invention, it is operated for the detection of surface and/or internal Discontinuities (2) of a Metallurgical Slab (105). The Conductive Structure (90) is then a cylindrical Metallurgical Slab (105) that is movable relative to the MLEMAT (89). The Apertures Loop (99), constituted by the virtual line joining the centers of each successive Grooved Cylindrical Aperture (39) of the Perforated Matrix Laminated Magnetic Core (22) of each adjacent EMAT (1) of the Laser-EMAT Probes (LEMAT) (82) of the MLEMAT (89), encircles the movable cylindrical Metallurgical Slab (105).

In another preferred implementation of the Multi-Laser-EMAT 3D scanner (MLEMAT) (89) of the invention, it is used for the detection of surface and/or internal Discontinuities (2) of a mobile cylindrical cast strand of Steel Slab (105), continuously cast in a steel mill at a casting temperature (TS) greater than 1000° C. The apertured HF Active Laminae (29) of each Perforated Matrix Laminated Magnetic Core (22) of each adjacent EMAT (1) of the MLEMAT (89) are made of a Magnetic Material, for example of the type ferromagnetic or ferrimagnetic, having a Curie Temperature (TC) lower than the Casting Temperature (TS). This Multi-Laser-EMAT 3D scanner (MLEMAT) (89) has the following characteristic. As shown in [FIG. 10], each Grooved Cylindrical Aperture (39) of each Perforated Matrix Laminated Magnetic Core (22) of each EMAT (1) of each adjacent LEMAT (82) of the MLEMAT (89), is connected to Cooling Means (58) generating a Cooling Flow (59) of a Heat-Transfer Fluid (60). The Heat-Transfer Fluid (60) is pushed under pressure inside each Via-Hole (41, 57) of the Grooved Cylindrical Aperture (39) of each Perforated Matrix Laminated Magnetic Core (22) of each adjacent EMAT (1) of the MLEMAT (89), at a Cooling Temperature (TF) significantly lower (by at least 50° C.) then the Curie Temperature (TC) of the Magnetic Material of the apertured HF Active Lamina (29).

The MLEMAT (89) of the invention, and its variants detailed above, offer a technical solution to the technical problem (c) above. This MLEMAT performs a continuous 3D scanning by line of large and thick mobile Conductive Structures (90), such as Metallurgical Slabs (105), from a single location, generating a 3D mapping observed at high resolution of this structure, including by providing the location of the surface and deep sub-surfaces Discontinuities (2). It operates at high temperatures of the Inspected Material (3) greater than 1000° C.

Referring to [FIG. 12], the Multi-Laser-EMAT 3D scanner (MLEMAT) (89) according to the invention as indicated above is seen, configured for the automatic adjustment of the dynamic parameters of the Dynamic Soft Reduction (DSR) of the cast strand of Steel Slab (105) continuously cast in a steel mill at a Casting Temperature (TS) greater than 1000° C. The cast strand of Steel Slab (105) is continuously pushed through a Dynamic Soft Reduction Device (DSRD), to suppress the formation of a macro-segregation zone and porosity zones within the cast strand of Steel Slab (105); thereby dynamically compensating for the solidification shrinkage of the steel and interrupting the suction flow rate of the residual molten metal in the Central Mushy Zone (106) of the Steel Slab (105).

This MLMAT (89) is coupled to a Dynamic Soft Reduction Device (DSRD) that comprises: i) a Dynamic 3D Mapping System (3DMS), generating a Dynamic 3D Mapping (3DM) of the cast strand of the Steel Slab (105); ii) a computerized DSR Optimization System (DSRM), generating Dynamic DSR Optimization Parameters (PCSD), based on the Dynamic 3D Mapping (3DM) and on the strand casting parameters; and iii) a Digital DSR Activator (ASR), dynamically adjusting the DSR Action Parameters (PASD) of the Dynamic Soft Reduction Device (DSRD), based on the PCSD generated by the DSRM.

This Multi-Laser-EMAT 3D scanner (MLEMAT) (89) has the following characteristics. The HF Electric Coils (6a, 6b, 6) of each EMAT (1a, 1b, 1) of each Laser-EMAT (82a, 82b, 82) of the MLEMAT (89) are each connected to the Dynamic 3D Mapping System (3DMS). They transmit thereto a Secondary Ultrasonic Electric Signal (88a, 88b, 88) induced in each HF Electric Coil (6a, 6b, 6) by the Material Eddy Currents (14) on the Frontal Zone (110) of the Inspected Material (3) of the Steel Slab (105) locally facing each EMAT (1a, 1b, 1). The DSR Optimization System (DSRM) is provided with Analog And Digital Processing Means (MDAN). The MDANs are configured to receive the multitude of Secondary Ultrasonic Electrical Signals (88a, 88b, 88) included in the Secondary Ultrasonic Electric Currents (19a, 19b, 19) traversing each HF Electric Coil (6) in each Laser-EMAT (82a, 82b, 82) of the MLEMAT (89). The MDANs are also configured to identify the changes and perturbations in each Secondary Ultrasonic Electric Signal (88a, 88b, 88) of each Laser-EMAT (82a, 82b, 82), caused by the Discontinuities (2) in the Local Active Fraction (44a, 44b, 44) of the Inspected Material (3) facing each Laser-EMAT (82a, 82b, 82), and digitally deducing therefrom and generating the Frontal Topology Of Defects (DTa, DTb, DT) in this Local Active Fraction (44a, 44b, 44). The MDANs are also configured to digitally combine the Frontal Topology Of Defects (DTa, DTb, DT), and digitally generating a three-dimensional Dynamic 3D Mapping (3DM) physically observed by the MLEMAT (89) of the interior of the cast strand of the Steel Slab (105), in the Frontal Zone (110) facing the Inspection Ring (100) in the Structure Section (92) of the Frame Plane (95), based on the combination and on the digital analysis of the combined signals of the multiple Secondary Ultrasonic Electric Signals (88a, 88b, 88).

As shown in [FIG. 10], the Cooling Means (58) generate a Cooling Flow (59) of a Heat-Transfer Fluid (60), thrust under pressure inside each Via-Hole (41, 57) of the Grooved Cylindrical Aperture (39) of each Perforated Matrix Laminated Magnetic Core (22) of each adjacent EMAT (1) of the MLEMAT (89); this at a Cooling Temperature (TF) markedly lower (by at least 50° C.) than the Curie Temperature (TC) of the Magnetic Material of the apertured HF Active Laminae (29).

It is understood that thanks to this MLEMAT (89), the DSR Action Parameters (PASD) of the Dynamic Soft Reduction Device (DSRD) can be adjusted dynamically in an optimal manner, on the basis of a Dynamic 3D Mapping (3 DM) of the cast strand of the Steel Slab (105) physically observed by the MLEMAT(89), this at a Casting Temperature (TS) greater than 1000° C.

Referring to [FIG. 12], a variant of the Multi-Laser-EMAT 3D scanner (MLEMAT) (89) is shown for the automatic adjustment of the dynamic parameters of the Dynamic Soft Reduction (DSR) which further allows the set-up of the Dynamic Secondary Cooling (DSC) of the cast strand of a Steel Slab (105) continuously cast in a steel mill at a Casting Temperature (TS) greater than 1000° C. The MLMAT (89) is coupled to a Dynamic Secondary Cooling Device (DSCD) which further comprises a computerized DSC Optimization System (DSCM), generating Dynamic DSC Optimization Parameters (PCSC) of the Dynamic Secondary Cooling (DSC) based on the physically observed Dynamic 3D Mapping (3DM) of the cast strand of the Steel Slab (105), in the Structure Section (92) of the Frame Plane (95), by the combination and digital analysis of the combined signals of the multiple Secondary Ultrasonic Electric Signals (88a, 88b, 88) in each Laser-EMAT (82a, 82b, 82) of the MLEMAT (89), and on the casting parameters. It also comprises a Digital DSC Activator (ASC), dynamically adjusting the DSC Action Parameters (PASC) of the water flow rate of the Dynamic Secondary Cooling (DSC), based on the PCSC generated by the DSCM, this on the basis of the Dynamic 3D Mapping (3DM) physically observed by the MLEMAT (89).

The MLEMAT (89) for the automatic adjustment of the DSR and/or DSC of the invention offers a technical solution to the technical problem (d) above. It ensures automatic adjustment of DSR Action Parameters (PASD) of the Dynamic Soft Reduction (DSR) and/or of the DSC Action Parameters (PASC) of the Dynamic Secondary Cooling (DSC), of a continuously cast strand of Steel Slabs (105) in a steel mill, based on the observed status of the inside of the cast strand of Steel Slab (105). It continuously supplies an observed Dynamic 3D Mapping (3DM) of the inside of the cast strand of Steel Slab (105). It continuously defines, in a 3D mode and in an observed manner, the location of the Central Mushy Zone (106) of the cast strand of a molten Steel Slab (105) and its segregation defects, based on a 3D physical observation, and not simply provided by a numerical simulation prediction by a theoretical algorithm based on a mathematical model. It detects precisely, the observed position of the reduction point of the cast strand of a Steel Slab (105), based on a 3D physical observation. It improves the accuracy and reliability of the automatic adjustment of the parameters of the Dynamic Soft Reduction (DSR) and of the Dynamic Secondary Cooling (DSC), of continuously cast strands of Steel Slabs (105), at temperatures above 1000° C. It makes it possible to reduce the segregation defects and the porosity in the Central Mushy Zone (106) of the structure of strands of molten Steel Slabs (105) during the continuous casting process in a steel mill.

### ADVANTAGEOUS EFFECTS OF INVENTION

The MLEMAT (89) for DSR and DSC of the invention offers valuable industrial advantages in the non-destructive automated control of hot cast strands of Steel Slabs, in the steel industry:
a. It can operate at a casting temperature of cast strands of Steel Slabs which may exceed 1200° C.
b. It can perform the continuous 3D mapping of the cast strands of Steel Slabs at a speed of up to 1 meter per second.
c. It allows the direct transit between the steel strand casting and the steel rolling, without the need of cooling down the Steel Slabs down to 100° C. max in order to proceed with their NDT with common instruments.
d. It saves the gas commonly used to reheat the Steel Slabs at 1200° C. after NDT and before rolling the steel.
e. It provides a 3D mapping observed continuously from cast strands of Steel Slabs, for automatically and dynamically adjusting the parameters of the continuous casting equipment.
f. It continuously identifies, with a high definition and reliability, all the types of (internal and surface) discontinuities in cast strands of Steel Slabs, as well as their coordinates.
g. It improves the standardization, the quality control, and the accuracy of the grading of quality the Steel Slabs produced and increases the added value of the continuous casting.
h. It provides an automatic precise adjustment in real time of the dynamic parameters for the DSR and/or the DSC of a continuously cast strand of Steel Slabs.
i. It provides an early detection of the discontinuities in the Steel Slabs, and it automatically allows their possible orientation towards the preceding production processes as a function of their quality, by inducing considerable savings in time, energy, materials, and work.
j. It increases the performance and productivity of a steel casting machine of 7% or more.
k. It can be installed without significant structural changes in the existing casting equipment of a steel mill since it is compact.

### INDUSTRIAL APPLICABILITY

The invention has industrial applications in the metallurgical industry, and in particular in the steel industry, for quality testing and automatic adjustment of DSR and/or DSC of hot strands of Steel Slabs at more than 1000° C. in continuous casting lines of steel, and for the quality control of semi-products of the metallurgical industry. The invention also has industrial applications in the railway industry, for the high-speed control of railway rails, and the control of the wheelsets mounted. The invention also has industrial applications in the oil and gas industry, chemistry, and nuclear industry, for the in-line tests of pipes and pipelines, drilling devices and equipment in hazardous and/or high-temperature environments.

Although only certain features of the invention have been illustrated and described herein, numerous modifications and changes will become apparent to those skilled in the art. It should therefore be understood that the appended claims are intended to cover all these modifications and changes which enter the true spirit of the invention.

1. An Electromagnetic Acoustic Transducer (EMAT) (1) for the detection of surface and internal Discontinuities (2) in an electrically conductive Inspected Material (3), comprising:
a. At least one Magnet (4) or an electromagnet, configured to generate a static or quasi - Static Magnetic Field (SMF) in the Inspected Material (3);
b. At least one HF Electric Coil (6), the latter being of the type
i. either, configured as an HF Electromagnetic Transmitter (9) of an Emitted HF Electromagnetic Field (HFEMF), if the EMAT (1) is used in Emission Mode (EM), and then it is connected to the output of at least one AC Current Source (11), driving an HF Alternating Current (AC) in the HF Electric Coil (6) at ultrasonic frequency,
inducing the Emitted HF Electro-Magnetic Field (HFEMF) in the direction of the Inspected Material (3),
producing Material Eddy Currents (14) on the surface of the Inspected Material (3),
generating Lorentz Forces (15) at ultrasonic frequency in the Inspected Material (3), by the interaction of the Material Eddy Currents (14) with the Static Magnetic Field (SMF) and/or a Magnetostriction,
the disturbance of which generates Primary Ultrasonic Waves (17) directly in the Inspected Material (3);
ii. and/or, configured as an HF Electromagnetic Receiver (18), if the EMAT (1) is used in Reception Mode (RM), and then it is traversed by a Secondary Ultrasonic Electrical Signal (88) at ultrasonic frequency,
generated by an Emitted HF Electromagnetic Field (HFEMF),
Induced by the Material Eddy Currents (14) produced on the Inspected Surface (8) of the Inspected Material (3) by Secondary Ultrasonic Waves (21), under the influence of an ultrasonic source, interacting with the Static Magnetic Field (SMF), and which are representative of the surface and internal Discontinuities (2) of the Inspected Material (3);
c. At least one Perforated Matrix Laminated Magnetic Core (22), configured to concentrate and direct the Emitted HF Electromagnetic Field (HFEMF) in the direction or coming from the Inspected Material (3); of the type comprising a sandwich Matrix (23),
i. consisting of a multitude of laminated Thin Sheets (24) stacked periodically along the Matrix Axis (25), these Thin Sheets (24) being positioned between the two main Matrix Faces (26) of the Sandwich Matrix (23), parallel to its Stacking Plan (27),
ii. having multiple adjacent lateral Edge Faces (35), extending substantially perpendicular to the Stacking Plan (27) and perpendicular to the Matrix Axis (25);
one of them, the First Edge Face (36) of the Matrix (23), facing the Inspected Surface (8) of the Inspected Material (3),
and the other, the Second Edge Face (37) of the Matrix (23) being situated substantially opposite the First Edge Face (36), and facing the HF Electric Coil (6);
iii. each laminated Thin Sheet (24) of the Matrix (23)
having a spatial geometry and lateral dimensions similar to those of the adjacent Thin Sheets (24) in the Matrix (23); and,
having two main lateral Sheet Surfaces (32), parallel to the Stacking Plan (27);
iv. of which, the combined successive adjacent Peripheral Edges (33) of each Thin Sheet (24) constitute a grooved Edge Surface (34) of the Matrix (23), surrounding the Matrix Axis (25), and,
v. defining a Core Axis (38) of the Matrix (23), substantially joining the centers of the First Edge Face (36) and the Second Edge Face (37); positioned substantially perpendicular to the Matrix Axis (25);
d. this sandwich Matrix (23) comprising at least one First Multitude (28) of HF Active Laminae (29) (or groups of such laminae), each of them
i. being isolated from one another,
ii. externally incorporating an electrically conductive material; and/or being covered externally with an electrically conductive layer on its Peripheral Edges (33), and,
iii. internally incorporating a Magnetic Material of ferromagnetic or ferrimagnetic type, and having a Curie Temperature (TC);
This Electromagnetic Acoustic Transducer (EMAT) (1) being characterized in combination in that:
a. It comprises a Grooved Cylindrical Aperture (39),
i. passing through each Thin Sheet (24) of the Matrix (23), along an Aperture Axis (40) of the Sandwich Matrix (23), substantially parallel to the Matrix Axis (25) and perpendicular to the Core Axis (38), and,
ii. opening onto each of the two lateral Matrix Faces (26);
b. It comprises a multitude of Magnetic Via-Holes (41),
i. of similar cross-sectional dimensions,
ii. perforated through and substantially at the centre of each of the multiple thus apertured HF Active Laminae (29) of the Matrix (23), along an axis substantially parallel to the Inspected Surface (8),
iii. having a Via-Hole’s Longitudinal Envelope (42), disposed along the Aperture Axis (40) of the Matrix (23), the lateral perimeter of which being continuously closed, and,
iv. aligned to form by their alignment the Grooved Cylindrical Aperture (39); and,
c. It comprises a multitude of closed Induced Current Loops (43) which, when the EMAT (1) is in operation, are
i. induced by the Emitted HF Electromagnetic Field (HFEMF), which is either emitted by the HF Alternating Current (AC) at ultrasonic frequency in the HF Electric Coil (6), and/or emitted by the Material Eddy Currents (14) at ultrasonic frequency in the Inspected Material (3),
ii. located within the Active Lamina Skin (48) of the periphery of each HF Active Lamina (29) of the Perforated Matrix Laminated Magnetic Core (22),
iii. arranged according to a Loops Mapping (LM), defining the topology and the relative positions of all the Induced Current Loops (43);
d. Each Magnetic Via-Hole (41) in each HF Active Lamina (29) is located between - the First Edge Face (36) facing the Inspected Surface (8), and - the Second Edge Face (37) facing the HF Electric Coil (6);
e. Each Magnetic Via-Hole (41) of the Grooved Cylindrical Aperture (39) is internally free of any hard material, and in particular is free of any electrical conductor passing through it;
f. The Loops Mapping (LM) is topologically discrete and consists of a multitude of discrete parts of Induced Current Loops (43) of the HF Active Laminae (29), (or groups of such HF Active Laminae) distant from each other;
g. The remote Induced Current Loops (43) (or group of such Loops),
i. are induced within the Active Lamina Skin (48) on the Peripheral Edges (33) of the HF Active Laminae (29),
ii. are each arranged along a plane of loops parallel to the Stacking Plan (27), and substantially perpendicular to the surface of the Inspected Material (3);
iii. are substantially parallel, and separated from one another, between their respective HF Active Lamina (29),
iv. encircle the Magnetic Via-Holes (41) of their HF Active Lamina (29) and rotate around it; and,
a. Each Core Spacing Slice (49) of the Perforated Matrix Laminated Magnetic Core (22) and of its surface, located between two adjacent HF Active Laminae (29) (or group), is free of any Induced Current Loops (43);
Such that a combined and interactive double physical effect occurs within the Perforated Matrix Laminated Magnetic Core (22):
a. Each of the multiple parallel and topologically discrete Induced Current Loops (43) of each apertured HF Active Lamina (29),
i. separately generates a high-frequency magnetic field,
ii. separately and locally increases the discrete and selective high-frequency magnetic coupling between a narrow Local Active Fraction (44) of the Inspected Surface (8) facing the HF Active Laminae (29), and the HF Electric Coil (6), and,
iii. participates in the mutual reduction of the high-frequency magnetic reluctance of the EMAT (1);
b. The Inner Perimeter (45) of each Magnetic Via-Hole (41) in each HF Active Lamina (29) of the Matrix (23),
i. creates a Heat-Conducting and Convective Surface (46) that is free inside the center of its HF Active Lamina (29),
ii. produces an internal Thermal Cooling effect to dissipate a fraction of the local electrical and calorific energy generated by the specific Induced Current Loop (43) of its specific HF Active Lamina (29), and,
iii. participates in the improvement of the efficiency of the EMAT (1).

2. An Electromagnetic Acoustic Transducer (EMAT) (1) according to claim 1, wherein:
a. Each apertured HF Active Lamina (29) of the Matrix (23) (or group of such Active Laminae) is separated from its neighbours, at the level of the adjacent Core Spacing Slices (49), by at least one sheet of a Second Multitude (54) of Passive Laminae (53) made of an electrically insulating material;
b. Each Passive Lamina (53) is perforated by a Spacer Via-Hole (57), and,
c. Each Passive Lamina (53) is positioned and configured such that:
i. The Magnetic Via-Holes (41) in the First Multitude (28) of HF Active Laminae (29) of the Matrix (23), as well as the Spacer Via-Holes (57) of the Second Multitude (54) of Passive Laminae (53) of the Sandwich Matrix (23),
ii. are aligned parallel to the Matrix Axis (25), to form by their alignment and their combination the Grooved Cylindrical Aperture (39);
This Electromagnetic Acoustic Transducer (EMAT) (1) being characterized in combination in that:
a. Each Spacer Via-Hole (57) in each Passive Lamina (53) is located between
i. the First Edge Face (36) facing the Inspected Material (3), and,
ii. the Second Edge Face (37) facing the HF Electric Coil (6); and,
b. Each Spacer Via-Hole (57) of its Grooved Cylindrical Aperture (39),
i. is internally free of any hard material,
ii. and in particular is free of any electrical conductor passing through it;
So that the inner periphery of each Spacer Via-Hole (57) in each Passive Lamina (53) of the Matrix (23) creates
a. A Heat-Conducting and Convective Surface (46) internal to the center of the Passive Lamina (53),
b. which produces an internal thermal cooling effect in this Spacer Via-Hole (57) in order to dissipate a fraction of the electrical and calorific energy generated by the Induced Current Loops (43) of the adjacent HF Active Laminae (29), and which participates in the improvement of the efficiency of the EMAT (1).

3. An Electromagnetic Acoustic Transducer (EMAT) (1) according to claim 2, characterized in that, for at least one Passive Lamina (53) and preferably for all,
a. The Peripheral Edges (33) of their peripheries are free of any conductive material covering their surfaces;
b. In such a way that the grooved Edge Surface (34) of the Perforated Matrix Laminated Magnetic Core (22) is not covered continuously and/or constituted by an electrically conductive layer, but on the contrary, it consists of alternating edges with edges, made on the one hand of conductive rings around the HF Active Laminae (29) and on the other hand of insulating rings around the Passive Laminae (53).

4. An Electromagnetic Acoustic Transducer (EMAT) (1) according to claim 1, of the type also comprising:
a. Cooling Means (58)
i. generating a Cooling Flow (59) of a Heat-Transfer Fluid (60) at a Cooling Temperature (TF),
ii. configured so that the Cooling Flow (59) is forced to pass through the Grooved Cylindrical Aperture (39) of the Matrix (23);
This Electromagnetic Acoustic Transducer (EMAT) (1) being characterized in combination in that:
a. The Cooling Flow (59) is configured
i. to pass successively through at least one Magnetic Via-Hole (41) of the First Multitude (28) and, alternatively, through at least one of the Spacer Via-Holes (57) of Second Multitude (54),
ii. to bootlick all of the Hole Wall Surfaces (62) of each successive Magnetic Via-Hole (41) and/or each Spacer Via-Hole (57) of the Matrix (23),
iii. to increase the internal thermal cooling effect in each HF Active Lamina (29) of the Matrix (23); each of them being the subject to an Induced Current Loop (43) and a heat dissipation; and,
b. The Cooling Temperature (TF) of the Cooling Flow (59) is lower by more than 50° C. than the specific Curie Temperature (TC) of the Magnetic Material of each apertured HF Active Lamina (29).

5. An Electromagnetic Acoustic Transducer (EMAT) (1) according to claim 4, characterized in that, in combination:
a. At least one (and preferably a multitude of) Thin Sheet(s) (24) of the Perforated Matrix Laminated Magnetic Core (22)
i. is - either pierced by a Cushion Hole (63), - or, provided with a Cushion Notch (64), passing through the Annular Wall (65) formed between their Via-Hole (41, 57), and the portion of their First Edge Face (36) facing the Inspected Material (3), in a direction parallel to the Stacking Plan (27),
ii. to create a Cushion Recess (66) between the Via-Holes (41, 57) of the Thin Sheet (24) and the First Edge Face (36) facing the Inspected Material (3); and,
b. The Cooling Means (58) are configured to
i. extract a Cushing Fluid Flow (67) from the Cooling Flow (59) flowing through the Via-Holes (41, 57),
ii. flow under pressure this Cushion Fluid Flow (67) extracted through the Cushion Recess (66),
iii. create a Lift Air Cushion (70) between the Perforated Matrix Laminated Magnetic Core (22) and the Inspected Material (3), at the level of the Cushion Recess (66) facing the Inspected Material (3), and,
iv. thus, lifting the Perforated Matrix Laminated Magnetic Core (22) above the Inspected Material (3) from a Cushion Gap (68).

6. An Electromagnetic Acoustic Transducer (EMAT) (1) according to claim 1, characterized in that, in combination:
a. The two outer Sheet Surfaces (32) of the two outer Thin Sheets located on the Matrix Faces (26) are either constituted, or covered by a Conductive Covering Layer (69), of an electrically conductive material;
b. A Via-Hole with transverse dimensions similar to those of the Magnetic Via-Holes (41) is perforated through each of the two Conductive Covering Layers (69);
c. The multiple Thin Sheets (24) and the two Conductive Covering Layers (69) of the Matrix (23) are positioned relative to one another, so that their multiple Via-Holes are aligned to form, by continuity, the Grooved Cylindrical Aperture (39).

7. An Electromagnetic Acoustic Transducer (EMAT) (1) according to claim 1, characterized in that:
a. The perimeter of each Magnetic Via-Hole (41) in each HF Active Lamina (29) is rectangular.

8. An Electromagnetic Acoustic Transducer (EMAT) (1) according to claim 7, characterized in that, in combination:
a. The center of each Magnetic Via-Hole (41) is substantially located at the center of gravity of its HF Active Lamina (29); and,
b. The perimeter of hole of each Magnetic Via-Hole (41) is positioned substantially at a constant Ring Distance (Rd) of the perimeter of its HF Active Lamina (29);
c. In such a way that each HF Active Lamina (29) is topologically configured as a rectangular Active Ring (71), thermodynamically cooled from the heating of the Induced Current Loop (43) generated around it.

9. An Electromagnetic Acoustic Transducer (EMAT) (1) according to claim 1, characterized in that:
a. The Second Edge Face (37) of the Perforated Matrix Laminated Magnetic Core (22) directly faces the HF Electric Coil (6), and,
b. No magnet is positioned between - on one side the Second Edge Face (37) of the Matrix (23) and - on the other side the HF Electric Coil (6).

10. An Electromagnetic Acoustic Transducer (EMAT) (1) according to claim 1, characterized in that:
a. the orientation, the pitch, the size, and the shape of each of the Circuit Facing Edges (72) of each HF Active Lamina (29), located in the Second Edge Face (37) of the Matrix (23), and facing the HF Electric Coil (6);
b. are consistent and correlated with the geometric parameters, including orientation, the pitch, the size, and the shape, of the Conductor Fractions (75) of the HF Electric Coil (6) successively facing each of these Circuit Facing Edges (72).

11. An Electromagnetic Acoustic Transducer (EMAT) (1) according to claim 10, wherein:
a. The HF Electric Coil (6) has at least one Fraction of Linear Conductor (73); and,
b. This Fraction of Linear Conductor (73) is positioned in proximity to and directly above a Circuit Facing Edge (72), and it is tangent along an axis parallel to this portion close to the perimeter of an HF Active Lamina (29) located in the Second Edge Face (37) of the Matrix (23) facing the HF Electric Coil (6);
This Electromagnetic Acoustic Transducer (EMAT) (1) being characterized in combination in that the Fraction of Linear Conductor (73) and the Perforated Matrix Laminated Magnetic Core (22) are configured such that, when the EMAT (1) is in operation, an Induced Current Loop (43)
a. is induced in the Active Lamina Skin (48) on the periphery of the HF Active Lamina (29),
b. surrounds its Magnetic Via-Hole (41),
c. so that this makes a local selective HF magnetic coupling between:
i. an HF Alternating Current (AC) driven in the Fraction of Linear Conductor (73) extending over and along the perimeter of the HF Active Lamina (29), and,
ii. the Material Eddy Currents (14) generated in the Local Active Fraction (44) of the Inspected Surface (8) facing the HF Active Lamina (29).

12. An Electromagnetic Acoustic Transducer (EMAT) (1) according to claim 11, wherein:
a. The HF Electric Coil (6) is of the type having a multitude of (at least two) Fractions of Linear Conductors (73); parallel and adjacent to one another, such as a Meander Circuit (74),
b. This multiple of parallel Fractions of Linear Conductor (73) are
i. positioned successively in proximity, and directly above a Circuit Facing Edge (72) of an HF Active Lamina (29), located in the Second Edge Face (37) of the Matrix (23) facing the HF Electric Coil (6), and,
ii. configured so that the HF Alternating Current (AC) flowing successively from the parallel and neighbouring Fractions of Linear Conductor (73) is oriented in alternating opposite directions;
c. At least one Conductor HF Magnetic Flux Loop (76) surrounds substantially perpendicularly each Fraction of Linear Conductor (73), and penetrates substantially perpendicularly inside the HF Active Lamina (29) facing it;
This Electromagnetic Acoustic Transducer (EMAT) (1) being characterized in that the Fractions of Linear Conductor (73) of the HF Electric Coil (6) and the Perforated Matrix Laminated Magnetic Core (22) are configured such that when the EMAT (1) is in Emission Mode (EM):
a. Two adjacent HF Active Laminae (29), surmounted by two adjacent Fractions of Linear Conductor (73),
b. Are traversed in their Active Lamina Skin (48) by two adjacent Induced Current Loops (43), each composed of an alternating HF electric current rotating in an opposite Direction Of Rotation (78), around the Aperture Axis (40) passing through their Magnetic Via-Holes (41), one being in the clockwise direction, while the other is in the anticlockwise direction.

13. An Electromagnetic Acoustic Transducer (EMAT) (1) according to claim 1, characterized in that, in combination:
a. The Aperture Depth (Od) of the Grooved Cylindrical Aperture (39) of its Perforated Matrix Laminated Magnetic Core (22), along its Aperture Axis (40),
b. is substantially equal and consistent with a First Transverse Dimension (FTd) of at least one HF Electric Coil (6) of the EMAT (1).

14. An Electromagnetic Acoustic Transducer (EMAT) (1) according to claim 1, characterized in that, in combination:
a. the grooved Second Edge Face (37) of its Perforated Matrix Laminated Magnetic Core (22), facing an HF Electric Coil (6),
b. has a transverse dimension, in a direction perpendicular to the Aperture Axis (40) of the Matrix (23), which is substantially equal and consistent with a Second Transverse Dimension (STd) of at least one HF Electric Coil (6) of the EMAT (1).

15. An Electromagnetic Acoustic Transducer (EMAT) (1) according to claim 1, characterized in that, in combination, the Sheet Geometric Dimensions of the perforated Thin Sheet (24) of its Perforated Matrix Laminated Magnetic Core (22) and/or the combined geometric dimensions of its Perforated Matrix Laminated Magnetic Core (22) are selected for:
a. Being decorrelated from the wavelengths of the principal harmonics of the Emitted HF Electro-Magnetic Field (HFEMF) field, and,
b. Preventing a mechanical resonance of its Perforated Matrix Laminated Magnetic Core (22) at the ultrasonic frequency of operation of the EMAT (1).

16. An Electromagnetic Acoustic Transducer (EMAT) (1) according to claim 1, characterized in that, in combination, the Sheet Geometric Dimensions of the perforated Thin Sheets (24) of its Perforated Matrix Laminated Magnetic Core (22) are, at the ultrasonic frequency of operation of the EMAT (1):
a. Either, lower than the wavelengths of the ultrasonic waves generated in these Thin Sheets (24),
b. Or, substantially equal to an odd number of quarters of the wavelengths of the ultrasonic waves generated in these Thin Sheets (24).

17. An Electromagnetic Acoustic Transducer (EMAT) (1) according to claim 1, of the type in which the grooved First Edge Face (36) of the Perforated Matrix Laminated Magnetic Core (22) facing the Inspected Material (3) and parallel to the Grooved Cylindrical Aperture (39) is either covered by, or covered with an Insulating Layer (81) made of, an electrically insulating material; this EMAT (1) being characterized in that further one of the sides of the Insulating Layer (81)
a. Is arranged facing the Grooved Cylindrical Aperture (39), and,
b. Covers, on the edge belonging to the First Edge Face (36), the perimeter of each of the apertured HF Active Laminae (29).

18. A Laser-EMAT Probe (LEMAT) (82), for inspecting a conductive Inspected Material (3), by receiving an ultrasonic signal from this Inspected Material (3), comprising the combination of:
a. An Electromagnetic Acoustic Transducer (EMAT) (1) according to any one of claims 1 to 17,
i. configured in Reception Mode (RM), for receiving an ultrasonic signal from the Inspected Material (3),
ii. the HF Electric Coil (6) of which is configured as an HF Electromagnetic Receiver (18),
induced by an Emitted HF Electromagnetic Field (HFEMF) emitted by the Inspected Material (3),
generated by the Material Eddy Currents (14), produced in the Inspected Material (3) by Secondary Ultrasonic Waves (21), representative of the surface and/or internal Discontinuities (2) of the Inspected Material (3), and,
iii. the Perforated Matrix Laminated Magnetic Core (22) of which
is located between the HF Electric Coil (6) of the EMAT (1) and the local surface of the Inspected Material (3), and,
directly faces the HF Electric Coil (6);
b. A Laser Source (84) configured for:
i. drawing a high energy Laser Beam (85) at a Firing Point (86) of the surface of the Inspected Material (3),
ii. generating ultrasonic waves producing Primary Ultrasonic Waves (17) propagating on the surface and/or inside the Inspected Material (3), and,
iii. causing the generation of Secondary Ultrasonic Waves (21) resulting from the echoes of the interactions of the Primary Ultrasonic Waves (17) with the Discontinuities (2) on and/or inside the Inspected Material (3), propagating on the surface and/or inside the Inspected Material (3),
iv. causing the generation of Material Eddy Currents (14) at the surface of the Inspected Material (3), induced by the mechanical vibrations of the Secondary Ultrasonic Waves (21) under the influence of the Static Magnetic Field (SMF) emitted by the Magnet (4) of the EMAT (1), and,
v. causing the induction of an Emitted HF Electromagnetic Field (HFEMF) emitted by the Material Eddy Currents (14) present on the surface of the Inspected Material (3), representative of the geometry and of the position of the surface and internal Discontinuities (2) of the Inspected Material (3);
This Laser-EMAT Probe (LEMAT) (82) is characterized in that:
a. A multitude of parallel and remote Induced Current Loops (43),
i. are induced by the Emitted HF Electromagnetic Field (HFEMF) emitted by the Material Eddy Currents (14) at ultrasonic frequency of the Inspected Material (3) under the influence of the Laser Source (84),
ii. within the Active Lamina Skin (48) on the Peripheral Edges (33) of each HF Active Lamina (29) of the Perforated Matrix Laminated Magnetic Core (22);
b. These Induced Current Loops (43) of each HF Active Lamina (29)
i. are spaced apart from one another,
ii. are each arranged along a plane of loops parallel to the Stacking Plan (27), and substantially perpendicular to the surface of the Inspected Material (3);
iii. surround and rotate around the Magnetic Via-Holes (41) of their HF Active Lamina (29);
iv. are located between the First Edge Face (36) facing the Inspected Material (3) and the Second Edge Face (37) facing the HF Electric Coil (6), and
v. are positioned substantially perpendicular to the two Edge Faces (36, 37);
Such that a combined and interactive double physical effect occurs within the Perforated Matrix Laminated Magnetic Core (22):
a. Each of the multiple parallel and topologically discrete Induced Current Loops (43) of each HF Active Lamina (29),
i. separately generates a high-frequency magnetic field,
ii. separately locally and discretely increases the high-frequency magnetic coupling between - a narrow Local Active Fraction (44) of the Inspected Surface (8) facing its HF Active Lamina (29), and - the HF Electric Coil (6), and,
iii. homogenizes the high-frequency coupling, and participates by mutualisation in the global reduction of the high-frequency magnetic reluctance, and in increasing the resolution of the EMAT (1);
b. The Inner Perimeter (45) of each Magnetic Via-Hole (41) in each HF Active Lamina (29) of the Matrix (23),
i. creates an internal free Heat-Conducting and Convective Surface (46) at the center of its HF Active Lamina (29), and,
ii. produces an internal Thermal Cooling effect to dissipate a fraction of the local electrical and calorific energy generated by the Induced Current Loop (43) of its specific HF Active Lamina (29), and,
iii. participates in the improvement of the efficiency of the EMAT (1).

19. A Multi-Laser-EMAT 3D scanner (MLEMAT) (89), for the detection of surface and/or internal Discontinuities (2) inside a mobile cylindrical Conductive Structure (90), comprising the combination of:
a. A Conductive Structure (90) to be 3D scanned,
i. made of an electrically conductive Inspected Material (3),
ii. having a cylindrical structure generated along a Structure Axis (91),
iii. having a substantially constant Structure Section (92);
b. A Chassis Frame (93),
i. configured to surround the Conductive Structure (90) at a Frame Distance (Fd),
ii. the Frame Plane (95) of which is substantially perpendicular to the Structure Axis (91) of the Conductive Structure (90);
c. A Probes Multitude (96) made of at least two Laser-EMAT probes (LEMAT) (82) according to claim 18, wherein each of the Laser-EMAT Probes (LEMAT) (82) is
i. fixed on the Chassis Frame (93), and,
ii. positioned and configured in such position that each of the First Edge Faces (36) of their Perforated Matrix Laminated Magnetic Core (22) faces the Conductive Structure (90);
d. Displacement Means (97) configured to move linearly
i. the cylindrical Conductive Structure (90) relative to the Chassis Frame (93),
ii. along a Displacement Direction (Md), substantially coincident with the Structure Axis (91);
This Multi-Laser-EMAT 3D scanner (MLEMAT) (89) is characterized in that:
a. The Apertures Loop (99),
i. constituted by the virtual line joining the centers of each successive Grooved Cylindrical Apertures (39) of the Perforated Matrix Laminated Magnetic Core (22) of each adjacent EMAT (1) of the Laser-EMAT Probes (LEMAT) (82) of the MLEMAT (89),
ii. encircles the Conductive Structure (90).

20. A Multi-Laser-EMAT 3D scanner (MLEMAT) (89) according to claim 19, characterized in that its Probes Multitude (96) made of Laser-EMAT Probes (LEMAT) (82) are attached to the Chassis Frame (93), positioned, and configured in a position such that:
a. The juxtaposition of the multitude of adjacent First Edge Faces (36) neighbouring the Perforated Matrix Laminated Magnetic Cores (22) of its adjacent Laser-EMAT (LEMAT) Probes (82), facing Inspected Material (3), are substantially contiguous with each other; and,
b. It constitutes a substantially continuous grooved Inspection Ring (100), surrounding and covering the perimeter of the Conductive Structure (90), in a Structure Section (92) of the Conductive Structure (90) close to the Frame Plane (95).

21. A Multi-Laser-EMAT 3D scanner (MLEMAT) (89) according to claim 19, of the type in which
a. The Laser Source (84) of each LEMAT (82) consists of an Optical Fibre (101), fixed to the Frame Plane (95), having a Firing End (102) facing the Conductive Structure (90); and,
b. Each Optical Fibre (101) is connected to a Laser Generator (103);
This Multi-Laser-EMAT 3D scanner (MLEMAT) (89) is characterized in that the Laser Firing Loop (104),
a. constituted by the virtual line joining the Firing Ends (102) of each adjacent Laser-EMAT Probe (LEMAT) (82) of the MLEMAT (89),
b. encircles the Conductive Structure (90) and is substantially parallel to the Apertures Loop (99).

22. A Multi-Laser-EMAT 3D scanner (MLEMAT) (89) according to claim 19, for the detection of surface and/or internal Discontinuities (2) of a Metallurgical Slab (105), in which:
a. The Conductive Structure (90) is a cylindrical Metallurgical Slab (105) that is movable relative to the MLEMAT (89);
This Multi-Laser-EMAT 3D scanner (MLEMAT) (89) is characterized in that:
a. The Apertures Loop (99), constituted by the virtual line joining the centers of each successive Grooved Cylindrical Aperture (39) of the Perforated Matrix Laminated Magnetic Core (22) of each adjacent EMAT (1) of the Laser-EMAT Probes (LEMAT) (82) of the MLEMAT (89), encircles the movable cylindrical Metallurgical Slab (105).

23. A Multi-Laser-EMAT 3D scanner (MLEMAT) (89) according to claim 22, for the detection of surface and/or internal Discontinuities (2) of a Steel Slab (105), of the type in which:
a. The Conductive Structure (90) is a mobile cylindrical cast strand of Steel Slab (105); continuously cast in a steel mill at a Casting Temperature (TS) greater than 1000° C., and,
b. The apertured HF Active Laminae (29) of each Perforated Matrix Laminated Magnetic Core (22) of each adjacent EMAT (1) of the MLEMAT (89) are made of a Magnetic Material, for example of the type ferromagnetic or ferrimagnetic, having a Curie Temperature (TC) lower than the Casting Temperature (TS);
This Multi-Laser-EMAT 3D scanner (MLEMAT) (89) being characterized in combination in that each Grooved Cylindrical Aperture (39) of each Perforated Matrix Laminated Magnetic Core (22) of each adjacent EMAT (1) of the MLEMAT (89) is connected to Cooling Means (58) generating a Cooling Flow (59) of a Heat-Transfer Fluid (60),
a. pushed under pressure inside each Via-Hole (41, 57) of the Grooved Cylindrical Aperture (39) of each Perforated Matrix Laminated Magnetic Core (22) of each adjacent EMAT (1) of the MLEMAT (89);
b. at a Cooling Temperature (TF) more than 50° C. lower than the Curie Temperature (TC) of the Magnetic Material of the apertured HF Active Laminae (29).

24. A Multi-Laser-EMAT 3D scanner (MLEMAT) (89) according to claim 23, for the automatic adjustment of the dynamic parameters of the Dynamic Soft Reduction (DSR) of the cast strand of a Steel Slab (105) continuously cast in a steel mill at a Casting Temperature (TS) greater than 1000° C., of the type in which:
a. The cast strand of Steel Slab (105) is continuously pushed through a Dynamic Soft Reduction Device (DSRD), to suppress the formation of a macro-segregation zone and porosity zones within the cast strand of the Steel Slab (105), thereby dynamically compensating for the solidification shrinkage of the steel and by interrupting the suction flow rate of the residual molten metal in the Central Mushy Zone (106);
b. The MLMAT (89) is coupled to this Dynamic Soft Reduction Device (DSRD) which comprises:
i. A Dynamic 3D Mapping System (3DMS), generating a Dynamic 3D Mapping (3DM) of the cast strand of the Steel Slab (105),
ii. A computerized DSR Optimization System (DSRM), generating Dynamic DSR Optimization Parameters (PCSD), based on the Dynamic 3D Mapping (3DM) and on the strand casting parameters, and,
c. A Digital DSR Activator (ASR), dynamically adjusting the DSR Action Parameters (PASD) of the Dynamic Soft Reduction Device (DSRD), based on the PCSD generated by the DSRM;
This Multi-Laser-EMAT 3D scanner (MLEMAT) (89) being characterized in combination in that:
a. The HF Electrical Coils (6a, 6b, 6) of each EMAT (1a, 1b, 1) of each Laser-EMAT (82a, 82b, 82) of the MLEMAT (89) are each connected to the Dynamic 3D Mapping System (3DMS), and transmit thereto a Secondary Ultrasonic Electric Signal (88a, 88b, 88) induced in each HF Electrical Coil (6a, 6b, 6) by the Material Eddy Currents (14) on the Frontal Zone (110) of the Inspected Material (3) of the Steel Slab (105) locally facing each EMAT (1a, 1b,1);
b. The DSR Optimization System (DSRM) is provided with Analog And Digital Processing Means (MDAN) configured for
i. Receiving the multitude of Secondary Ultrasonic Electrical Signals (88a, 88b, 88) included in the Secondary Ultrasonic Electric Currents (19a,19b, 19) traversing each HF Electric Coil (6a, 6b, 6) in each Laser-EMAT (82a, 82b, 82) of the MLEMAT (89), and,
ii. Identifying the changes and perturbations in each Secondary Ultrasonic Electrical Signal (88a, 88b, 88) of each Laser-EMAT (82a, 82b, 82), caused by the Discontinuities (2) in the Local Active Fraction (44a, 44b, 44) of the Inspected Material (3) facing each Laser-EMAT (82a, 82b, 82), and digitally deducing therefrom and generating the Frontal Topology Of Defects (DTa, DTb, DT) in this Local Active Fraction (44a, 44b, 44), and,
iii. Digitally combining the Frontal Topology Of Defects (DTa, DTb, DT), and digitally generating a three-dimensional Dynamic 3D Mapping (3DM) physically observed by the MLEMAT (89) of the interior of the cast strand of Steel Slab (105), in the Frontal Zone (110) facing the Inspection Ring (100) in the Structure Section (92) of the Frame Plane (95), based on the combination and on the digital analysis of combined signals of the multiple Secondary Ultrasonic Electrical Signals (88a, 88b, 88); and,
c. The Cooling Means (58) generate a Cooling Flow (59) of a Heat-Transfer Fluid (60),
i. thrust under pressure inside each Via-Hole (41, 57) of the Grooved Cylindrical Aperture (39) of each Perforated Matrix Laminated Magnetic Core (22) of each adjacent EMAT (1a,1b, 1) of the MLEMAT (89);
ii. at a Cooling Temperature (TF) markedly lower (by at least 50° C.) than the Curie Temperature (TC) of the Magnetic Material of the apertured HF Active Lamina (29);
d. So that the DSR Action Parameters (PASD) of the Dynamic Soft Reduction Device (DSRD) can be adjusted dynamically and automatically in an optimal manner, on the basis of a Dynamic 3D Mapping (3DM) of the cast strand of Steel Slab (105) physically observed by the MLEMAT (89), this at a Casting Temperature (TS) greater than 1000° C.

25. A Multi-Laser-EMAT 3D scanner (MLEMAT) (89) according to claim 24, for the automatic adjustment of the dynamic parameters of the Dynamic Soft Reduction (DSR) which further allows the set-up of the Dynamic Secondary Cooling (DSC) of the cast strand of Steel Slab (105) continuously cast in a steel mill at a Casting Temperature (TS) greater than 1000° C., characterized in that the MLEMAT (89) is coupled to a Dynamic Secondary Cooling Device (DSCD) which further comprises:
a. A computerized DSC Optimization System (DSCM), generating Dynamic DSC Optimization Parameters (PCSC) based
i. on the physically observed Dynamic 3D Mapping (3DM) of the cast strand of Steel Slab (105), in the Structure Section (92) of the Frame Plane (95), by the combination and digital analysis of the combined signals of the multiple Secondary Ultrasonic Electric Signals (88a, 88b, 88) in each Laser-EMAT (82a, 82b, 82) of the MLEMAT (89),
ii. and on the casting parameters;
b. A Digital DSC Activator (ASC), dynamically adjusting the DSC Action Parameters (PASC) of Dynamic Secondary Cooling (DSC) of the water flow rate of the Secondary Dynamic Cooling (DSC), based on the PCSC generated by the DSC Optimization System (DSCM), this on the basis of the Dynamic 3D Mapping (3DM) physically observed by the MLEMAT (89).
